(19) United States
(12) Patent Application Publication
(10) Pub. No.: US 2015/0248758 A1
(43) Pub. Date: Sep. 3, 2015

(54) SYSTEM AND METHOD FOR ESTIMATING A QUANTITY OF INTEREST IN A KINEMATIC SYSTEM BY CONTRAST AGENT TOMOGRAPHY

(71) Applicant: OLEA MEDICAL, La Ciotat (FR)

(72) Inventor: Fabrice Pautot, La Ciotat (FR)

(73) Assignee: OLEA MEDICAL, La Ciotat (FR)

(21) Appl. No.: 14/433,605

(22) PCT Filed: Oct. 7, 2013
(86) PCT No.: PCT/FR2013/052381

§ 371 Date: Apr. 3, 2015

(30) Foreign Application Priority Data
Oct. 5, 2012 (FR) 1259479

(51) Int. Cl. G06T 7/00; G06T 7/20

(52) U.S. Cl. CPC G06T 7/0016; G06T 7/2006; G06T 2207/10081; G06T 2207/10096; G06T 2207/10104; G06T 2207/10108; G06T 2207/30016; G06T 2207/30048; G06T 2207/30104

(57) ABSTRACT

This invention relates to a method for producing and outputting a quantity of interest relative to a flow within a polyhedral space of a kinematic system, advantageously implemented by a processing unit of a tomographic imaging system. The invention applies, specifically but not limited, to the estimation of volumetric flows or plasma, interstitial or compound volumes relative to the flow of a contrast agent within an organ by permeability or perfusion imaging.

This invention relates to a method for estimating a quantity of interest relative to a flow within a polyhedral space of a kinematic system, advantageously implemented by a processing unit of a tomographic imaging system. The invention applies, specifically but not limited, to the estimation of volumetric flows, or plasma, interstitial or compound volumes relative to the flow of a contrast agent within an organ by permeability or perfusion imaging. The invention is notably different from known methods in that it consists in estimating, for each volume of interest, for example a parallelepiped voxel, not just one volumetric flow, but each of the six flows—at least five of which are free—across each face of said voxel respectively.

The invention is based mainly on tomographic imaging techniques such as Perfusion Weighted Magnetic Resonance Imaging (PW-MRI) Dynamic Susceptibility Contrast Imaging (DSC) Computed Tomography Perfusion Imaging (CTP), Micro-Computed Tomography Perfusion Imaging, Arterial Spin Labelling Imaging (ASL) or Ultrasound Perfusion Imaging.

The invention can also be based on permeability imaging techniques such as Dynamic Contrast Enhanced Imaging (DCE) by Magnetic Resonance (DCE-MR) or by Computed Tomography (DCE-CT), Positron Emission Tomography (PET) or Single Photon Emission Computed Tomography (SPECT).

These techniques enable valuable information on the hemodynamics of organs such as the brain or the heart to be quickly obtained. This information is particularly crucial for a practitioner seeking to make a diagnosis, give a prognosis or take a therapeutic decision regarding the treatment of diseases such as strokes or cancer tumours. For example, cerebral ischemia is characterised mainly by a collapse of blood flows in the occluded vascular territory; neoangiogenesis caused by the expansion of a cancer tumour can be characterised by an increase in blood flows, etc.

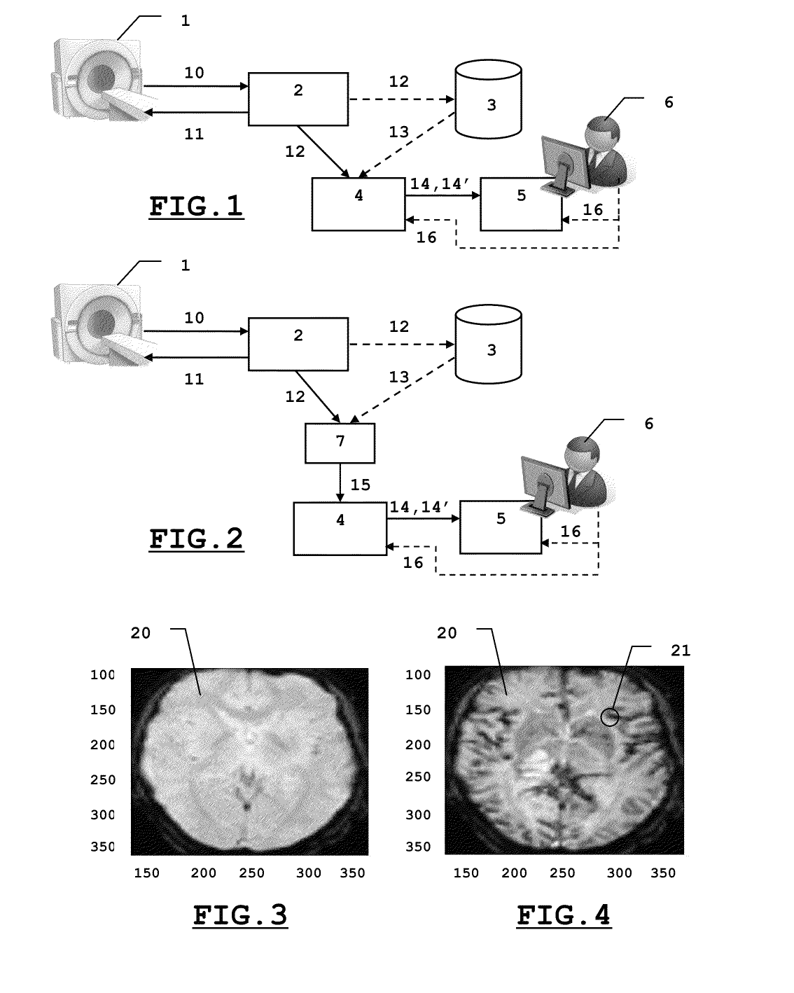

In order to implement these techniques, a Nuclear Magnetic Resonance or Tomographic Imaging device 1 operated via a console 2 (as shown in FIG. 1) is used. A user can thus select parameters 11 to control the device. The latter delivers a plurality of sequences of digital images 12 of a part of the body, in particular the brain. To achieve this, said device applies a combination of high-frequency electromagnetic waves onto the part of the body in question and measures an intensity signal 10 re-emitted by certain atoms. The device thus allows the chemical composition and therefore the nature of the biological tissues in each elementary volume of the imaged volume (usually called a “voxel”) to be determined.

The sequences of images are optionally stored by a server 3 and usually constitute a patient's medical file 13. Such a file can contain images of different types (perfusion, permeability, etc.). The sequences are analysed by means of a dedicated processing unit 4. Ultimately, this processing unit delivers—by means of an output device 5 providing a graphic, acoustic or other image—to a practitioner 6 by means of an appropriate man-machine interface, an estimation of one or more quantities of interest 14 (possibly formatted in the form of a content 14′) such as hemodynamic parameters. The practitioner can thus perform a diagnosis and decide on the therapeutic action that he deems appropriate. He can also parameterise the processing unit or output device with the aid of user commands 16. A variation exists, described by way of example in FIG. 2, for which an imaging system as previously described also includes a pre-processing unit 7 to analyse the sequence of images 12 in order to deduce therefrom experimental (perfusion or permeability) signals 15 and deliver them to the processing unit 4 which is thus relieved of this task.

FIG. 3 shows an example of a typical image 12 of a 5 millimetre thick slice of a human brain. This image is obtained by Nuclear Magnetic Resonance. With the help of this technique, for each slice a matrix of 128×128 voxels, measuring 1.5×1.5×5 millimetres, can be obtained. With the aid of bilinear interpolation, a flat image of 458×458 pixels can be obtained, such as image 20.

Dynamic perfusion or permeability images are obtained either by intravenously injecting an exogenous contrast agent (such as a gadolinium chelate for DSC-MR, iodine for CTP, a radionuclide for PET and SPECT or even a gas such as xenon) or by generating an endogenous contrast agent (by spin labelling the arterial blood in the case of ASL) then by measuring over time a signal relating to the concentration of said contrast agent in each voxel of the image. s(x,y,z,t) is the signal thus obtained for the voxel of spatial coordinates (x,y,z).

FIG. 4 shows an image 20 similar to that shown in FIG. 3. However, this image is obtained after an injection of a contrast agent. This image is an example of a typical perfusion image of a brain. The arteries thus appear clearly in contrast to the same image described in FIG. 3.

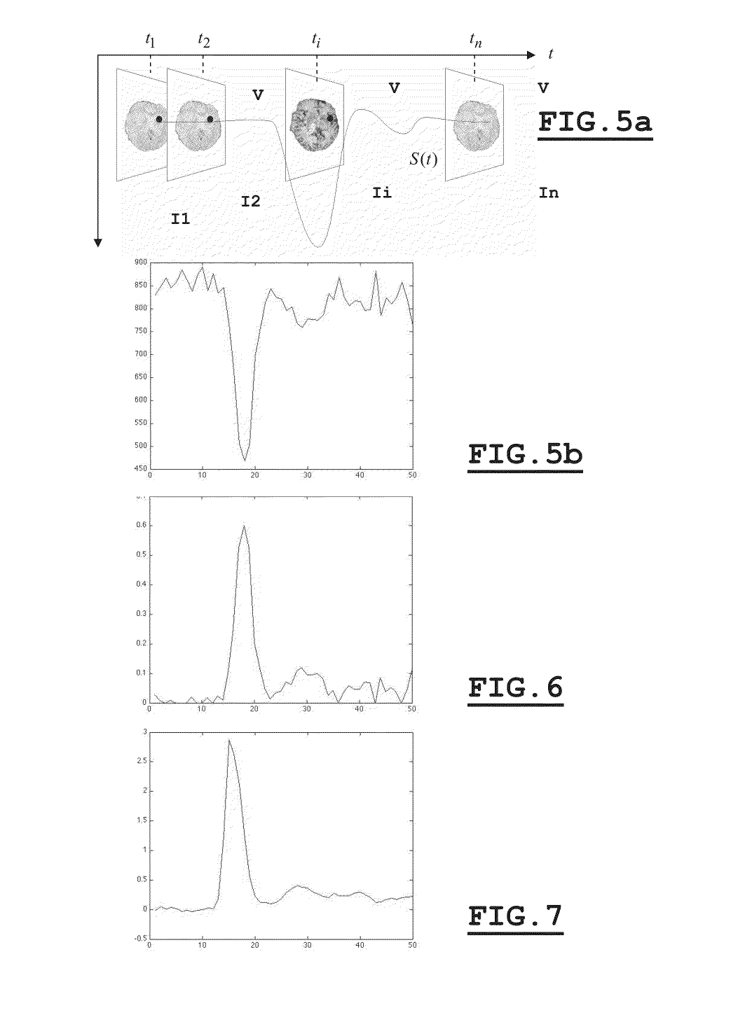

FIG. 5b shows an example of a perfusion signal s(x,y,z,t) by Nuclear Magnetic Resonance such as the signals 15 delivered by the pre-processing unit 7 described in connection with FIG. 2. The perfusion signal is thus representative of the development of the concentration of a contrast agent in a voxel over a period of time t following an injection of said contrast agent. By way of example, FIG. 5b describes such a signal over a period of 50 seconds. The y-axis describes the intensity of the signal whose unit is arbitrary. In order to obtain this signal, the processing unit 4 in FIG. 1 (or in a variation the pre-processing unit 7 in FIG. 2), analyses a sequence of n Nuclear Magnetic Resonance perfusion images I1, I2, . . . , Ii, . . . , In at times t₁, t₂, . . . , tᵢ, . . . , tₙ as illustrated, by way of example, in FIG. 5a.

Signals s(x,y,z,t) are first of all converted into concentration curves c(x,y,z,t) of said contrast agent. For example, in computed tomography perfusion, the signal for each voxel is typically presumed to be proportional to the concentration:

s(x,y,z,t)=k·c(x,y,z,t)+s₀(x,y,z)

In DSC-MR perfusion imaging, an exponential relation is typically presumed to exist:

s(x,y,z,t)=s₀(x,y,z)·e^{-k·TE·c(x,y,z,t)}

In both cases s₀(x,y,z) represents the average intensity of the signal before the arrival of the contrast agent and k is a constant. Its value in each voxel being unknown, it is fixed at an arbitrary value for all of the voxels of interest. Relative, not absolute, estimations are thus obtained. This relative information is still pertinent, however, since it is of interest mainly due to the relative variation of these values in the space, particularly between the healthy tissues and the diseased tissues.

FIG. 6 shows a concentration curve deduced from a perfusion signal like the one described in FIG. 5b. FIG. 6 thus enables visualisation over time of the development of the mass concentration of a contrast agent within a voxel. A high-amplitude peak can be observed during the first pass of the contrast agent in the voxel, followed by smaller amplitude peaks relating to a recirculation phenomenon (second pass) of said contrast agent.

FIG. 7 shows a typical arterial input function cₐ(t) representing the circulation of a contrast agent within an arterial voxel such as the voxel 21 shown in FIG. 4. FIG. 7 illustrates in particular that the recirculation phenomenon after a first pass of the contrast agent is very weak.

The concentration curves c(x,y,z,t) thus obtained by these techniques are described by the mathematical models of the transport phenomena of the contrast agent in each voxel of interest.

In the case of perfusion imaging, the standard model is the Meier and Zierler model which can be written in a differential form:

$$\frac{\partial c ( x , y , z , t )}{\partial t} = BF ( x , y , z ) [ {c}_{a} ( x , y , z , t ) - {c}_{v} ( x , y , z , t ) ]$$

where cₐ(x,y,z,t) is the concentration of the contrast agent in the artery supplying the volume of tissue contained in said voxel (Arterial Input Function AIF), cᵥ(x,y,z,t) is the concentration of the contrast agent in the vein draining the volume of tissue contained in said voxel (Venous Output Function—VOF) and BF is the Blood Flow.

Since the artery/tissue/vein dynamic system is linear and stationary (Linear Time-invariant—LTI), there is an impulse response or probability density function of the transit time in the volume of tissue h(x,y,z,t) so that cᵥ(x,y,z,t)=cₐ(x,y,z,t)\textcircled{×}h(x,y,z,t) where \textcircled{×} denotes the convolution product.

By introducing the additional distribution function of the transit time in the volume of tissue (known as the residue function)

$$R ( x , y , z , t ) = u ( t ) - {\int }_{0}^{t} h ( x , y , z , τ ) d τ$$

where u(t) is the generalised Heaviside Step Function, the solution of the previous differential equation with the initial condition c(x,y,z,t=0)=0 is written as c(x,y,z,t)=BF(x,y,z)·cₐ(x,y,z,t)\textcircled{×}R(x,y,z,t), which constitutes the integral form of Meier and Zierler's standard perfusion model.

Based on the additional distribution function of the transit time of the blood in the volume of tissue, the Mean Transit Time (MTT) of the blood in the tissue is defined by:

$$MTT ( x , y , z ) = {\int }_{0}^{+ ∞} t \cdot h ( x , y , z , t ) d t = {\int }_{0}^{+ ∞} R ( x , y , z , t ) d t$$

The Blood Volume (BV) per unit of volume is also defined by the relation:

$$BV ( x , y , z ) = \frac{{\int }_{0}^{+ ∞} c ( x , y , z , t ) d t}{{\int }_{0}^{+ ∞} {c}_{a} ( x , y , z , t ) d t}$$

Giving the relation: BV(x,y,z)=BF(x,y,z)·MTT(x,y,z).

Considering that the measurement of the development of the condition of the artery/tissue/vein system is c(x,y,z,t), the following must be collectively estimated:
the system itself, namely its additional distribution function R(x,y,z,t) (or its impulse response h(x,y,z,t));
the hemodynamic parameters such as BF, MTT and BV;
system input cₐ(x,y,z,t) or output cᵥ(x,y,z,t).

This problem comes down to a conventional one of estimating the parameters to be processed for example by the maximum likelihood method, the least squares method or the Bayes method, if theoretical parametric models are available for the arterial input cₐ(x,y,z,t) and the additional distribution function R(x,y,z,t).

In fact, tested parametric models are available for arterial input functions such as Gamma-variate models. However, the Meier and Zierler perfusion model can be written again in the equivalent form:

$$c ( x , y , z , t ) = \frac{BF ( x , y , z )}{λ ( x , y , z )} \cdot [ λ ( x , y , z ) \cdot {c}_{a} ( x , y , z , t ) ] ⊗ R ( x , y , z , t )$$

for all non-zero λ(x,y,z). A constraint must therefore be added in the parametric model of cₐ(x,y,z,t) allowing the constant λ(x,y,z) to be fixed for all of the voxels of interest, without which only the product BF(x,y,z)·cₐ(x,y,z,t) can be estimated but not each of its terms. For example such constraint can be

$$∀ ( x , y , z ) , {\int }_{0}^{+ ∞} {c}_{a} ( x , y , z , t ) d t = {c}_{0}$$

The problem is therefore twofold. On the one hand, it is hard to see how to prove that such a constraint must necessarily be verified. On the other hand, since the local arterial input functions cannot be observed within the Meier and Zierler perfusion model because they are not spatially localised, it is impossible to ensure a posteriori whether said constraint is verified or not and, consequently, to ensure the relevance of the estimations of the parameters resulting therefrom.

For this reason it is customary to ignore the problem of estimating the local arterial input functions for each voxel of interest by assuming them as known, given beforehand. Various approaches have therefore been suggested in order to provide these functions.

In a first approach, the practitioner selects an experimental global arterial input function manually. It can be measured, for example, at the contralateral cerebral artery or at the internal carotid artery for brain perfusion imaging, or obtained by additional measurements, such as optical measurements. Although it allows signals with high signal-to-noise ratios to be obtained, this approach nevertheless has considerable drawbacks. Firstly, it requires human intervention and/or additional measurements. This is not desirable in a clinical emergency situation and makes the procedures and final results more difficult to output. Secondly and more importantly, this global arterial input function does not correspond to the local arterial input functions for each voxel. It differs in terms of delay (because local arterial input functions usually lag behind the global arterial input function which is often taken upstream of the vascular system) and in terms of dispersion (because the propagation of the contrast agent is slower downstream than upstream of the vascular system, so that the arterial input functions are more staggered and more dispersed downstream of the vascular system). Yet it is known that in the end these phenomena have a considerable influence on the estimations of hemodynamic parameters since, by symmetry of the convolution product, these faults have a direct impact on the estimation of the additional distribution function. Thus, for example, in the end an estimation of the real mean transit time MTT between the local arterial input function and the local venous output function is not obtained but only a mean transit time between the global arterial input function and the local venous output function. In order to make up for these discrepancies, some authors have introduced new parameters in the Meier and Zierler model such as the parameter

$$TMAX = {arg max}_{t} R ( t )$$

quantifying the delay between the global arterial input function and the local arterial input function, although they do not alter the original standard perfusion model (in which the arterial input function is deemed to be the real local arterial input function for each voxel). Other methods tend to minimise the influence of the differences between the global and local arterial input functions on the estimation of hemodynamic parameters. However, they introduce new unknowns into the global problem and simply ignore it, as we shall see later.

According to a second approach, a global arterial input function is obtained automatically from perfusion images via signal processing techniques such as data clustering or Independent Component Analysis (ICA). Although this approach makes it possible to do away with human intervention, it does not resolve the problems of delay and dispersion inherent in global arterial input functions and introduces new unknowns (e.g. venous output functions may be obtained instead of arterial input functions). Moreover, these functions are often obtained by averaging several arterial input functions taken in different places, so that they are no longer localised in the space and, consequently, have no physical and physiological significance.

According to a third approach, local arterial input functions are obtained automatically from perfusion images with the aid of signal processing techniques and selection criteria. For example, the “best” function is sought in the neighbourhood of the current tissue voxel where we wish the hemodynamic parameters to be estimated. The object of this third approach is again ultimately to obtain less biased and more accurate estimations by overcoming, at least in part, the problems of delay and dispersion. However, nothing guarantees a priori and a posteriori that the local arterial input functions thus obtained are “close” to the “real local function” for the voxel of interest. For example, this “real” function might not be located in the neighbourhood under consideration (if it is too small) or, by contrast, could be confused with another arterial input function (if it is too big). Moreover, this “better” local arterial input function is sought among “normal” arterial input functions (i.e. with a short contrast agent arrival time, a large amplitude, etc.). But, quite the contrary, we seek precisely to identify and distinguish between normal arterial input functions and pathological, for example ischemic, arterial input functions. Consequently, even if the final results obtained with this local approach may appear to be “better” than with the global approaches previously described, the uncertainties surrounding these local arterial input functions, selected from the most normal and, a fortiori, on the estimations of hemodynamic parameters or the resulting complementary cumulative density functions or residue functions, remain largely unresolved.

These approaches are therefore not totally satisfactory. Moreover, if it can be assumed that the arterial input functions are given a priori, then why, by analogy, can one not or should one not assume the venous output functions cᵥ(x,y,z,t) also to be known a priori? This would at least have the merit of greatly simplifying the problem of estimating the hemodynamic parameters since there would no longer be any need to deconvolute the concentration curves by means of the arterial input functions. Indeed, the Meier and Zierler model could be directly adjusted in its differential form

$$\frac{\partial c ( x , y , z , t )}{\partial t} = BF ( x , y , z ) [ {c}_{a} ( x , y , z , t ) - {c}_{v} ( x , y , z , t ) ]$$

for example by the least linear squares method in order to estimate BF(x,y,z). However, if following the first approach described previously cₐ(x,y,z,t) and cᵥ(x,y,z,t) are globally fixed for all of the voxels of interest, the MTT would be constant across all of the voxels, so that there would no longer be just one hemodynamic parameter BF(x,y,z) per voxel. Avoiding the problem of estimating local arterial input functions somewhat contradicts the Meier and Zierler model.

Moreover, unlike arterial input functions or venous output functions, tested parametric models for the functions of additional distribution R(t) cannot be provided because they cannot, by definition, be directly observed and tested. Yet digital simulations have shown that the slightest error of specification regarding the form of the parametric model of R(t) (or h(t)) causes considerable unacceptable errors as regards hemodynamic parameters such as BF, MTT or BV. For this reason, various different nonparametric approaches have been introduced, within which the form of the additional distribution functions is not fixed a priori. Thus, the problem of estimating the hemodynamic parameters comes back to a problem of nonparametric deconvolution of the concentration curves by the given arterial input functions.

Since the problem of nonparametric deconvolution has been intrinsically badly resolved, it is therefore necessary to regularise the solutions in one way or another by constraining them in any event to observe certain different and varied constraints. Again, as stated previously, it is impossible to verify a posteriori whether these constraints are satisfactory. Consequently, it is impossible to verify a posteriori whether the estimations of the parameters resulting therefrom are valid. This is why many deconvolution methods exist, providing estimations of hemodynamic parameters that could potentially be very different from each other. These methods have numerous theoretical drawbacks (leading, for example, to the obtention of estimations that contradict the theoretical perfusion model) and create numerous practical difficulties (mainly in determining regularisation parameters), which would take too long to describe here. The result of this is lack of consensus as regards the choice of any one particular method, preventing standardisation of post-processing of contrast agent tomography, particularly in the medical field.

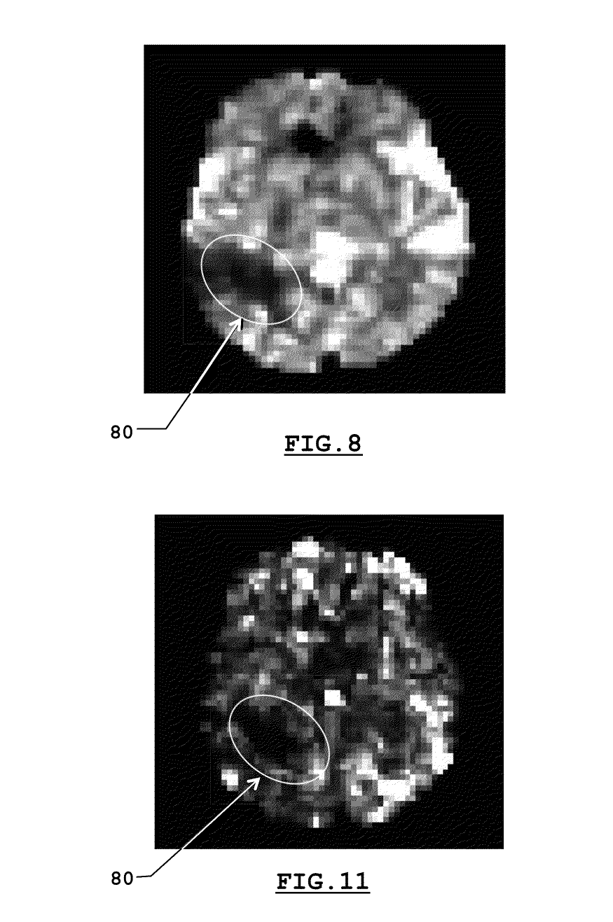

By way of example, FIG. 8 shows a typical map of BF estimations obtained by DSC-MR. This figure shows a case of cerebral ischemia. A hypo-perfused area 80 is clearly visible in the right hemisphere corresponding to the vascular territory of the artery blocked by a blood clot.

The standard perfusion model also raises numerous questions, such as:
if a flow is defined across a surface, from which surface BF(x,y,z) does the flow come?
where are the arterial input function cₐ(x,y,z,t) and the venous output function cᵥ(x,y,z,t) for each voxel spatially located? In particular, from which MTT(x,y,z) path is the mean transit time?
Is it logical to define just one mean transit time MTT(x,y,z) for each voxel even if the latter is non-cubic? Should not at least three mean transit times be defined for each of the voxel's three spatial dimensions?
Should not the blood flow BF(x,y,z), the mean transit time MTT(x,y,z) and the blood volume BV(x,y,z) depend on the size of the voxel?

Moreover, as regards perfusion imaging where it is assumed that the contrast agent is intravascular, in permeability imaging, it is considered that part of said contrast agent can pass from the intravascular medium to the extravascular medium. Several known parametric models therefore allow the concentration curves of the contrast agent in each voxel to be described, including:
the Kety model, usually written in the differential form:

$$\frac{\partial c ( x , y , z , t )}{\partial t} = {K}_{Trans} ( x , y , z ) \cdot {c}_{p} ( x , y , z , t ) - {k}_{ep} ( x , y , z ) \cdot c ( x , y , z , t )$$

or in the integral form:

c(x,y,z,t)=K_{Trans}(x,y,z)·cₚ(x,y,z,t)\textcircled{×}exp [−kₑₚ(x,y,z)t]
the extended Kety-Tofts or Tofts-Kermode model, usually written in the integral form:

c(x,y,z,t)=vₚ(x,y,z)·cₚ(x,y,z,t)+K_{Trans}(x,y,z)\textcircled{×}exp [−kₑₚ(x,y,z)t]
The St Lawrence and Lee model, usually written in the integral form:

$$c ( x , y , z , t ) = F ( x , y , z ) \cdot {c}_{p} ( x , y , z , t ) ⊗ \{ {χ}_{[ 0 , Tc ]} ( t ) + {χ}_{] {T}_{c} , + ∞ [} ( t ) E ( x , y , z ) exp [ - \frac{F ( x , y , z ) E ( x , y , z )}{{v}_{e} ( x , y , z )} ( t - {T}_{c} ( x , y , z ) ) ] \}$$

where:
cₚ(x,y,z,t) indicates in all cases the plasma concentration of the contrast agent in the artery supplying the volume of tissue contained in the voxel (Plasmatic Arterial Input Function—PIF);
\textcircled{×} indicates the Volterra convolution product;
K_{Trans}, kₑₚ, vₚ, F, E, vₑ, T_{c} . . . are the respective parameters of the models.

We can see that the permeability models are mathematically quite similar to the Meier and Zierler perfusion model in its integral form (i.e. these are convolution models).

Consequently, they also raise a large number of conceptual questions, namely:
as a flow is defined only across one surface, from which surfaces are flows K_{Trans}(x,y,z) or F(x,y,z)?
where is the plasmatic input function cₚ(x,y,z,t) spatially located?
why has the venous output function cᵥ(x,y,z,t) of the standard perfusion model disappeared in the permeability models, since the fact that the blood is no longer necessarily confined to the vascular system does not necessarily mean that there is no longer any venous output?
since intravascular perfusion is simply a particular case of permeability, when the latter is zero, why is the Meier and Zierler perfusion model not a particular case of different permeability models? Why, by contrast, does it include the different models of parametric permeability as particular cases when the additional distribution function is not specified? Are the perfusion and permeability models only mutually compatible? How can they be combined?

The same sort of practical difficulties that are encountered in perfusion imaging are encountered in permeability imaging. In particular, the plasmatic input functions cₚ(x,y,z,t) should be locally estimated by adding a constraint in order to define the problem clearly. Now, here again, as this limit cannot be verified experimentally, it is customary to give this or these plasmatic input functions a priori, as previously stated.

Furthermore, unlike the Meier and Zierler perfusion model, permeability models are parametric. As previously stated, we know that if the parametric model of the convolution core is inappropriate, aberrant estimations of hemodynamic parameters may be obtained. This is a particularly tricky problem in the Saint Lawrence and Lee model. The latter is often preferred to the Kety and Kety-Tofts-Kermode models because it allows the intravascular phases to be separated (over an interval of time [0,T_{c}]) and extravascular (over an interval of time ]T_{c},+∞[). However, the intravascular convolution core is presumed constant over [0,T_{c}]. This hypothesis implies amongst other things (by analogy with the Meier and Zierler perfusion model) that the intravascular transit time is always strictly equal to T_{c} (i.e. that h(t)=δ(t−T_{c}) where δ( ) is the Dirac generalised function). This implies that, in particular, there is only one microcapillary path (as opposed to the capillary bath) between the arterial input and the venous output. Now, this hypothesis is highly improbable. Moreover, the convolution core is highly discontinuous at time t=T_{c} since it passes from 1 for t≦T_{c} to E for t>T_{c}. It should however be expected, by virtue of the Continuity Principle, that there would a smooth transition between the intravascular and extravascular phases.

The numerous difficulties, both conceptual and technical, inherent in state-of-the-art perfusion and permeability models might therefore indicate that they are, in some ways, unsuitable although used for a very long time and of established clinical usefulness. In order to highlight the origin of this theoretical insufficiency, we shall begin by recalling some concepts of Fluid Kinematics.

Let us consider a three-dimensional flow in a kinematic system such as an organ for example. We fix a Galilean reference frame (O,\vec{x},\vec{y},\vec{z}) typically immobile for this organ, after implementing, for example, a rigid (e.g. movement correction) or non-rigid (e.g. for resilient organs such as the liver or heart) time pre-coregistration phase. \vec{v}(x,y,z,t) being the Eulerian velocity vector field at time t at the coordinate point (x,y,z). Σ being a given oriented control surface of unitary local surface vector \vec{dΣ}.

The flow or volumetric flow rate Φ_{Σ}^{ρv}(t)l across the surface Σ at time t is defined by

$${Φ}_{Σ}^{v} ( t ) = {\int \int }_{Σ} \vec{v} ( x , y , z , t ) \cdot \vec{d Σ}$$

or, in an equivalent manner, by

$${Φ}_{Σ}^{v} ( t ) = \frac{\partial {V}_{Σ}}{\partial t} ( t )$$

where V_{Σ}(t) is the volume crossing the surface Σ in the interval of time [t,t+∂t].

For an outgoing oriented closed surface Σ, the Green-Ostrogradskv divergence theorem is written:

$${Φ}_{Σ}^{v} ( t ) = {Σ}_{} \vec{v} ( x , y , z , t ) \cdot \vec{d Σ} = {\int \int \int }_{V} \vec{∇} \cdot \vec{v} ( x , y , z , t ) d x d y d z$$

where V is the volume delimited by Σ. For an incompressible, homogenous or inhomogeneous flow, we have by definition \vec{∇}·\vec{v}(x,y,z,t)=div\vec{v}(x,y,z,t)≡0.

By applying the Green-Ostrogradsky divergence theorem, it follows that the volumetric flow of an incompressible flow across a closed oriented surface is zero.

For a stationary or permanent flow, the different quantities defined previously are independent of time.

Let us now try to establish the standard Meier and Zierler perfusion model from these basic concepts. For this, let us consider the flow of an incompressible fluid transporting a contrast agent. m(x,y,z,t) being the mass of the contrast agent in a voxel with coordinates (x,y,z) and volume V and

$$c ( x , y , z , t ) = \frac{m ( x , y , z , t )}{V}$$

being the mass concentration of said agent.

Let us consider, in the Meier and Zierler model, an outgoing oriented closed surface Σ fixed in relation to the Galilean reference frame (O,\vec{x},\vec{y},\vec{z}), consisting of one incoming surface Σ_{E} and one outgoing surface Σ_{S}. Σ_{R} being the remaining surface: we therefore have Σ=Σ_{E}∪Σ_{S}∪Σ_{R}. We can see Σ as the surface of a pipe or tube, Σ_{E} being the input section of the pipe, Σ_{S} the output section of the pipe and Σ_{R} the surface of the pipe itself.

Let Φ_{Σ}_{_{E}}^{v}(t), Φ_{Σ}_{_{S}}^{v}(t) and Φ_{Σ}_{_{R}}^{v}(t) be the volumetric flows across the surfaces Σ_{E}, Σ_{S} and Σ_{R} respectively at time t. By application of the Green-Ostrogradsky divergence theorem for an incompressible flow and additivity, we have on the one hand:

$${Φ}_{Σ}^{v} ( t ) = {Σ}_{} \vec{v} ( x , y , z , t ) \cdot \vec{d Σ} = {\int \int }_{{Σ}_{E}} \vec{v} ( x , y , z , t ) \cdot \vec{d Σ} + {\int \int }_{{Σ}_{S}} \vec{v} ( x , y , z , t ) \cdot \vec{d Σ} + {\int \int }_{{Σ}_{R}} \vec{v} ( x , y , z , t ) \cdot \vec{d Σ} = {Φ}_{{Σ}_{E}}^{v} ( t ) + {Φ}_{{Σ}_{S}}^{v} ( t ) + {Φ}_{{Σ}_{R}}^{v} ( t ) = 0$$

and on the other hand Φ_{Σ}_{_{R}}^{v}(t)≡0 because the velocity is zero on Σ_{R}, so that Φ_{Σ}_{_{S}}^{v}(t)=−Φ_{Σ}_{_{E}}^{v}(t)≡Φ(t). We can therefore define one and only total volumetric flow that is not necessarily zero Φ(t) at time t for such a system.

In general, we can assume that the inhomogeneous fluid in a voxel of interest consists of a fluid occupying the extravascular space (Extravascular Fluid—EF), namely the interstitium, of a fluid occupying the intravascular space (Intravascular Fluid—IF), namely the blood, as well as Blood Vessels (BV) themselves. By additivity we therefore have:

Φ(t)=Φ^{IF+EF+BV}(t)=Φ^{IF}(t)+Φ^{EF}(t)+Φ^{BV}(t)

The assumption being, within the context of the Meier and Zierler model, that the artery supplying the voxel and the vein draining it contain only intravascular blood, we have de facto Φ^{EF}(t)=Φ^{BF}(t)≡0 so that Φ(t)=Φ^{IF}(t).

Supposing, moreover, that the vessels are immobile in relation to the voxel, the intravascular volume is constant over time: V^{IF}(t)≡V^{IF}.

Since blood itself consists of plasma (P) transporting the contrast agent as well as the formed elements (Blood Cells-C), we have:

Φ(t)=Φ^{IF}(t)=Φ^{P}(t)+Φ^{C}(t)

Let us now write down the mass balance of the contrast agent in the system delimited by Σ, during an infinitesimal lapse of time [t,t+∂t].

The variation of the mass of the contrast agent is written as:

∂m(t)=∂[V·c(t)]=V·∂c(t)=m_{E}(t)−m_{S}(t)

where:
V is the measurement of the volume delimited by the closed control surface Σ;
m_{E}(t) is the mass of the incoming contrast agent across surface Σ_{E};
m_{S}(t) is the mass of the outgoing contrast agent across surface Σ_{S}.

Supposing the contrast agent to be uniformly diluted in the fluid transporting it (i.e. the plasma), so that the mass is proportional to the volume, we have by definition:

$${m}_{E} ( t ) = {V}_{E} ( t ) \cdot {c}_{E} ( t ) = {c}_{E} ( t ) \cdot \frac{\partial {V}_{E}}{\partial t} ( t ) \cdot \partial t = {c}_{E} ( t ) \cdot {Φ}_{E} ( t ) \cdot \partial t$$

where V_{E}(t) is the volume of incoming plasma across Σ_{E} in the time interval [t,t+∂t], c_{E}(t) is the plasma mass concentration of the contrast agent and Φ_{E}(t) its volumetric flow across Σ_{E}. Similarly: mₛ(t)=Vₛ(t)·c_{S}(t)·Φ_{S}(t)·∂t.

Since the mass concentration of the contrast agent in a volume V of the artery supplying the system delimited by Σ, is equal by hypothesis to cₐ(t), we have

$${c}_{E} ( t ) = \frac{{c}_{a} ( t ) \cdot V}{{V}_{AIF}^{P}}$$

where V^{AIF}^{P} is the subvolume of plasma contained in a measurement volume V of the artery. In the same way, the concentration of the contrast agent in the plasma leaving the system delimited by Σ is

$${c}_{S} ( t ) = \frac{c ( t ) \cdot V}{{V}^{P}}$$

where V^{P} is the subvolume of plasma contained in the volume delimited by Σ, not

$${c}_{S} ( t ) = \frac{{c}_{v} ( t ) \cdot V}{{V}_{VOF}^{P}}$$

where V_{VOF}^{P} is the volume of plasma contained in a measurement volume V of the vein draining the system delimited by Σ.

We therefore have:

$$\partial m ( t ) = V \cdot \partial c ( t ) = {m}_{E} ( t ) - {m}_{S} ( t ) = [ \frac{{c}_{a} ( t ) \cdot V}{{V}_{AIF}^{P}} \cdot {Φ}_{E} ( t ) - \frac{c ( t ) \cdot V}{{V}^{P}} \cdot {Φ}_{S} ( t ) ] \cdot \partial t$$

Let us also suppose, in the context of the Meier and Zierler model, that the ratio

$$\frac{{Φ}^{C} ( t )}{{Φ}^{IF} ( t )}$$

is constant throughout and equal to the haematocrit fraction Ht. We therefore have Φ^{P}(t)=(1−Ht)·Φ^{IF}(t), Φ^{C}(t)=Ht·Φ^{IF}(t) and

$$Φ ( t ) = {Φ}^{IF} ( t ) = {Φ}^{P} ( t ) + {Φ}^{C} ( t ) = {Φ}^{P} ( t ) + Ht \cdot \frac{{Φ}^{P} ( t )}{1 - Ht} = \frac{1}{1 - Ht} \cdot {Φ}^{P} ( t )$$

so that a single signed plasma flow Φ^{P}(t) exists, incoming across Σ_{E} and outgoing across Σ_{S} so that Φ_{E}(t)=Φ_{S}(t)=Φ^{P}(t)=Φ(t)·(1−Ht).

It follows that

$$\frac{\partial c}{\partial t} ( t ) = {Φ}^{P} ( t ) \cdot [ \frac{{c}_{a} ( t )}{{V}_{AIF}^{P}} - \frac{{c}_{v} ( t )}{{V}^{P}} ] .$$

Assuming lastly that the flow is permanent so that Φ^{P}(t)≡Φ^{P}, finally we have:

$$\frac{\partial c}{\partial t} ( t ) = {Φ}^{P} \cdot [ {c}_{a} ( t ) / {V}_{AIF}^{P} - c ( t ) / {V}^{P} ]$$

Unless cᵥ(t)=c(t) and V_{AIF}^{P}=V^{P}, which is not necessarily the case, this model does not correspond to the differential model of Meier and Zierler

$$\frac{\partial c}{\partial t} ( t ) = BF \cdot [ {c}_{a} ( t ) - {c}_{v} ( t ) ]$$

but, on the contrary, to the differential permeability model of Kety

$$\frac{\partial c}{\partial t} ( t ) = {K}^{trans} \cdot {c}_{a} ( t ) - {k}_{ep} \cdot c ( t )$$

if we substitute

$${K}^{trans} = \frac{{Φ}^{P}}{{V}_{AIF}^{P}}$$

and

$${k}_{ep} = \frac{{Φ}^{P}}{{V}^{P}} .$$

We can thus see that the Meier and Zierler model cannot apply to a flow whose overall direction is known a priori. In fact, the outgoing concentration of the contrast agent must then be a function of the concentration c(t) in the volume delimited by Σ and not a function of the concentration cᵥ(t) in the vein draining this system, which plays no role whatsoever.

The Meier and Zierler model can at best apply only to a flow whose overall direction is not known a priori. Yet, the very fact of naming, let alone specifying, the arterial input function and the venous output function as the respective concentration curves cₐ(t) and cᵥ(t) or the fact of assuming BF to be positive implies that one assumes the overall direction of the flow to be known a priori, i.e. from the artery towards the vein.

Moreover, if the direction of flow is not known a priori, the kinetic model is then formed by two equiprobable a priori models, conditional upon the overall direction of the flow or, in an equivalent manner, upon the sign of volumetric flow Φ^{P}:

$$M : \{ \begin{matrix}M \vert {Φ}^{P} \geq 0 : \frac{\partial c ( t )}{\partial t} = {Φ}^{P} [ {c}_{a} ( t ) / {V}_{AIF}^{P} - c ( t ) / {V}^{P} ] \\ M \vert {Φ}^{P} < 0 : \frac{\partial c ( t )}{\partial t} = - {Φ}^{P} \{ {c}_{v} ( t ) / {V}_{VOP}^{P} - c ( t ) / {V}^{P} \}\end{matrix}$$

This model does not always correspond to the standard perfusion model of Meier and Zierler. It follows that this model is applicable to none of the cases in point and that it must be replaced by the above-described Kety type model when the direction of flow is known a priori.

On the basis of the definition of volumetric flow in Fluid Kinematics, the Green-Ostrogradsky divergence theorem for an incompressible flow and the principle of conservation of mass, we have therefore established a Kety type local kinetic differential model for a flow of pipe type intravascular contrast agent whose direction is known a priori.

We can thus conclude that this model applies at most to a flow in a pipe or tube with one inlet orifice and one outlet orifice. This is necessary in order to be able to define a single volumetric flow that is not necessarily zero Φ(t) for this system then a single plasma flow Φ^{P}(t), the total volumetric flow, incoming or outgoing, being necessarily zero due to the hypothesis of incompressibility.

Yet, in perfusion or permeability imaging, the Meier and Zierler perfusion model or the permeability models such as the Kety model are used to describe the phenomena of transportation of a contrast agent in a voxel. This voxel is a rectangular parallelepiped whose closed surface is formed by six faces. Generally speaking, it is not therefore possible to define beforehand either one incoming surface for said voxel or one outgoing surface, so it is not possible to define one total not necessarily zero volumetric flow Φ(t) for this voxel, as said models require. On the contrary, the Green-Ostrogradsky divergence theorem for an incompressible flow implies that the total volumetric flow, incoming or outgoing, across the closed surface of such a voxel is zero.

Thus, the plasma volumetric flow Φ

of the above-mentioned Kety type model cannot be the plasma volumetric flow (across the closed surface) of a voxel since it is usually not zero. Similarly, there is no need to estimate the plasma volumetric flow (across the closed surface) of a voxel since it is zero according to the hypotheses of the Meier and Zierler model and the above-mentioned Kety type model. It follows that, generally speaking, all of these models are inadequate to describe the phenomena of transporting a contrast agent in a voxel since they define a single non-zero flow whereas the flow (across the closed surface) of a voxel is zero. Consequently, they cannot constitute admissible perfusion or permeability models from the point of view of Fluid Kinematics.

In other words, if Φ^{P} is indeed a flow in the sense of Mechanics, then it is necessarily taken across an open surface of the voxel because it is generally not zero. So, as this surface is not given, defined, that is to say localised in space and time, this quantity will not be a flow in the sense of Mechanics. Since it cannot be defined, we must admit that Φ_{P}, and even more so the BF of the standard perfusion model, are anything but flows. In any event, the physical dimension of BF in the Meier and Zierler is T⁻¹, so BF cannot be a volumetric flow of dimension L³T⁻¹ or a mass flow of dimension MT⁻¹.

However, can the above-mentioned Kety type model describe an intravascular flow of a contrast agent in a voxel in certain specific cases?

Let us suppose that the flow in the voxel is of the type envisaged by Meier and Zierler: pipe type flow comprising one incoming surface Σ_{E} and one outgoing surface E_{S}. This is typically the case when the voxel contains only one blood vessel whose section is small in relation to the dimensions of the voxel. Let us further suppose that the direction of flow is known a priori.

Can the Kety type model then be applied? It can only be so if and only if said incoming and outgoing surfaces were known and given a priori. In fact, a volumetric flow in the sense of Fluid Mechanics is defined across a given surface. A volumetric flow across a virtual surface cannot be defined because Mechanics only deals with physical, and therefore real magnitudes. Yet, in general, these incoming and outgoing surfaces are not known a priori, or in any case not precisely (i.e. neither the position nor the orientation of the blood vessels are known, or at least not precisely known a priori) especially if only perfusion or permeability images are available that need to be properly processed in order to extract from them the information available. On the contrary, we would wish to be able to determine a posteriori whether these surfaces exist and, if they do, to then determine their orientations. So neither does the Kety type model apply to a pipe type flow unless it (i.e. the surfaces Σ_{E}, Σ_{S} and Σ_{R}) is given a priori.

Let us now suppose that the pipe and its incoming and outgoing sections are given a priori. The Kety type model cannot then be applied except in certain very specific cases, namely when said incoming and outgoing surfaces are each located on at least one of the six faces of the voxel. In fact, on the one hand the Kety type (or Meier and Zierler) models assume that the concentrations of contrast agent are spatially uniform in the immediate external neighbourhood of the incoming and outgoing surfaces, equal to cₐ(t) and cᵥ(t) respectively. On the other hand, the supposedly uniform concentrations of the contrast agent in the six neighbouring voxels of the current voxel are measured. Yet these concentrations are not a priori equal to each other. So, if the incoming and outgoing surfaces consist of several faces of the voxel, we assume the concentrations to be the same, which experimentally they are not necessarily so. There is a contradiction here.

We can therefore see that the Kety type model can only apply in the case of a pipe type flow and only when said pipe is known a priori and its incoming and outgoing sections each lie on only one of the six faces of the voxel. Furthermore, by virtue of the Principle of Locality in Classical Physics, the concentration curve cₐ(t) must be taken in the immediate external neighbourhood of the pipe inlet according to Meier and Zierler. Yet assuming that said pipe exists, this is often not the case, particularly when a global arterial input function, separated from the current voxel as explained previously, is used.

Lastly, we must bear in mind that the pipe according to Meier and Zierler must be contained in the voxel in question or more generally in the elementary volume defined by the tomographic measurement technique adopted. In particular, the surface Σ_{R} of the pipe must be contained in the volume of the voxel so that the flow across the surface of the voxel without Σ_{E} and Σ_{S} is zero. This implies that the section of the pipe-vessels must be smaller than the dimensions of the voxel, which constitutes a constraint that is clearly breached for the large vessels such as arteries or veins given the actual typical dimensions of voxels are in the order of one millimetre. If this is not the case, in other words if the section of the pipe is distributed over several neighbouring voxels, it must be assumed that the flow is parallel to the faces of the voxel (or even more improbable hypotheses) so that again the flow across these faces is zero. Yet this geometrical condition has a probability of zero.

The Kety type model (and even more so the Meier and Zierler model) is therefore inadequate to describe the phenomena of transportation of a contrast agent in the main cases of interest. The same applies to the other known perfusion models, particularly the models used in ASL, CTP and DSC-MR since, as long as they define only one input or one “flow” per voxel, they also implicitly assume a pipe type flow.

The same also applies to conventional permeability models, whether the models used in DCE-MR and DCE-CT like standard Kety models, extended Kety-Tofts-Kermode and St Lawrence and Lee models, or the models used in SPECT and PET since they also define a single “flux” (K_{Trans} for Kety and Kety-Tofts-Kermode models, F Saint Lawrence and Lee model and CBF in PET and SPECT) and are based on a single plasmatic arterial input function.

The basic limitations underlying known perfusion and permeability models are therefore understood: an incorrect application of the Principle of Conservation of Mass to virtual systems, i.e. pipes, instead of the correct application of this principle to the physical systems given a priori by tomographic imaging techniques, i.e. the voxels.

The present invention allows these limitations to be overcome and to solve the drawbacks arising from adopting known methods, by proposing models, for example perfusion or permeability models, derived from and not contradicting Fluid Kinematics.

Among the numerous advantages conferred by the invention, we can mention, in a non-limiting way, the fact of:
mainly reconciling the techniques of perfusion and permeability imaging with Fluid Mechanics, particularly with the Principle of Locality and the Principle of Conservation of Mass;
mainly unifying the techniques of perfusion and permeability imaging into one theoretical framework;
enabling an estimation of the volumetric flow and subvolumes in the sense of Fluid Mechanics and thus preventing any doubtful estimation of flux without surface, mean transit time without a point of departure or point of arrival and regardless of the dimension of the voxels (elementary volumes defined by the tomographic measurement technique adopted);
enabling a better understanding of the phenomena linked to a flow within a kinematic system such as the circulation of blood within an organ for example by means of tomographic imaging (and perfusion and permeability imaging in particular);
knowing the limits of application of a method according to the invention by specifying the hypotheses on which any rigorously proven model is based;
eliminating all superfluous or undesirable hypotheses such as, for example, the LTI hypothesis, ignoring interstitial flows in the Meier and Zierler and Kety type models, etc.;
no longer adopting obscure or even doubtful virtual concepts such as arterial input functions and local but not localised venous output functions, additional impulse and distribution responses connecting them, delay and dispersion phenomena, etc.;
eliminating numerous false problems such as the determination or estimation of arterial input functions or local or global but not localised venous output functions, the management of delay and dispersion phenomena, partial volumes, etc.;
providing estimations of quantities of interest such as volumetric flows or quasi-absolute subvolumes of fluids transporting a contrast agent, whatever the imaging technique adopted;
defining models such as simple and complete three-dimensional permeability and perfusion models that require no introduction of any external quantity;
automatically producing estimations of the quantity of interest such as volumetric flows or volumes, without recourse to any human intervention, so as to increase reproducibility and therefore confidence in said estimation;
making comparable estimations of the same parameter deriving from different imaging methods, different equipment or different experimental conditions;
facilitating multicentre clinical trials;
facilitating and making it possible to standardise post-processing of tomographic data such as the segmentation of the different parts of an organ (e.g. white and grey matter for the brain), the definition and segmentation of pathological areas (e.g. heart and ischemic penumbra in the case of cerebral vascular accidents and cancer tumours) and the recognition of diseases (e.g. grading cancer tumours);
producing and displaying current lines, trajectories, emission lines or fluid lines, so as to obtain new dynamic tractography and angiography techniques by tomography using a conventional contrast agent;
producing and displaying new quantities of interest such as the time taken by fluids to travel along trajectories, velocities, accelerations, particle jerks or snaps, etc.;
considerably speeding up the process of diagnosis, prognosis, deciding on treatment and patient care;
facilitating the diagnosis and prognosis of the practitioner to the benefit of patients;
enabling physiopathology and anatomopathology to progress smoothly on the basis of reliable theories.

In the light of this, the invention envisages a method for estimating a quantity of interest relative to a flow of a fluid in a kinematic system based on experimental signals delivered by a tomographic measurement system and relating to the concentrations of a contrast agent within given polyhedral volumes, said method being implemented by a processing unit. According to the invention, this method comprises a step for estimating said quantity of interest from a kinetic and parametric model comprising a plurality of parameters including a flow across a face of one of said given polyhedral volumes.

According to a preferred embodiment, the invention envisages that said kinetic model can comprise a plurality of parameters including a flow across each face of one of said given polyhedral volumes.

In order to reduce the processing time required for the estimation of the quantity of interest, the kinetic and parametric model can advantageously be expressed in the form of a piecewise bilinear model in the volumetric flows across the faces of one of said given polyhedral volumes and subvolumes. The step for estimating said quantity of interest can therefore include a step for estimating the parameters of the model by means of an alternating linear least squares method.

In order to quantify the uncertainty concerning the estimation of the quantity of interest or the adequacy of the kinetic model for experimental data, the method may include a step for producing an additional quantity associated with the estimated quantity of interest or associated with said kinetic model.

According to a preferred application, the flow can be that of a body fluid in an organ of interest.

According to the invention, the quantity of interest can be a flow across a face of a given polyhedral volume, a flow per unit of surface, a subvolume of said given polyhedral volume, a flow velocity vector, a flow velocity, a local mean transit time from a given polyhedral volume to one of its neighbours, a particle acceleration vector, a particle acceleration, a particle jerk vector, a particle jerk, a particle snap vector, a particle snap, a total quadratic or absolute flow or a maximum quadratic or absolute flow. Said estimated quantity of interest can also be a field of flows across respective faces of given polyhedral volumes, a field of subvolumes of said given polyhedral volumes, a field of flow velocity vectors, a field of flow velocities, a position of a material point of the fluid, a range of local mean transit times from a given polyhedral volume to one of its neighbours, a field of particle acceleration vectors, a field of particle accelerations, a field of particle jerk vectors, a field of particle jerks, a field of particle snap vectors, a field of particle snaps, a field of total absolute or quadratic flows, a field of maximum absolute or quadratic flows or a propagation time along a trajectory of the flow. In this case, the method may advantageously also comprise a step for estimating a trajectory, a current line, an emission line or a fluid line based on a previously estimated field of velocity vectors.

In order to facilitate the processing operations of a device tasked with outputting an estimation and indeed to be able to export said estimation, a method to produce an estimation of a quantity of interest according to the invention may also include a step for producing a content representing said quantity of interest, said content being destined to be used by a suitable output device. Such a method may also include a step for delivering the content previously produced.

As the invention enables novel quantities of interest to be estimated, its second object concerns an output method for said quantity of interest relative to a flow of body fluid in an organ based on experimental signals delivered by a tomographic measurement system and relating to the concentrations of a contrast agent within given polyhedral volumes. Said method is implemented by an output device comprising a man/machine interface. In particular, certain quantities of interest are henceforth respectively associated with a face of a polyhedral volume. For said quantity of interest, the method of output includes a stage for outputting, via said man/machine interface, a representation of a face of a polyhedral volume depending on the value of the quantity of interest for said face. In a variation, the output stage may consist in outputting, via said man/machine interface, a representation of a plurality of faces of a polyhedral volume depending on the values of the quantity of interest for said faces. This step can also consist in outputting, via said man/machine interface, a representation of a polyhedral volume depending on the value of a quantity of interest associated with a face of a polyhedral volume.

For a vectorial quantity of interest associated with a polyhedral volume, the output step may consist in outputting an arrow whose length is proportional to a norm of the vectorial quantity associated with said volume and whose direction is that of said quantity.

In a variation, said step may consist in outputting a representation of a coloured polyhedral volume from three primary colours whose respective intensities depend on the components of the vectorial quantity associated with said volume.

Advantageously, a method of estimation according to the invention may include a step for outputting a trajectory, a current line, an emission line or a fluid line. In order output this novel item, an output method according to the invention may comprise a step for outputting, via a suitable man/machine interface, a representation of a parameterised arc corresponding to the trajectory or the current line or the emission line or the fluid line. Furthermore, a representation of a position in the parameterised arc may be coloured at any moment with a colour depending on the value of a quantity of interest at that moment. The invention also envisages that at any moment a representation of the portion of the parameterised arc travelled up until that moment can be outputted.

The invention also envisages a particularly novel method for assisting a practitioner to provide a diagnosis by outputting, via a man/machine interface of an output device, a quantity of interest relative to a flow of body fluid in an organ on the basis of experimental signals delivered by a tomographic measurement system and relating to the concentrations of a contrast agent within given polyhedral volumes. Such a method advantageously includes a step for outputting, via said man/machine interface, a choropleth representation of a volume deformed by anamorphosis in accordance with said quantity of interest.

So as to be able to implement an estimation method according to the invention, the latter relates to a processing unit comprising storage means, means to communicate with the outside world and processing means. The communication means of said unit are capable of receiving from the outside world experimental signals delivered by a tomographic measurement system and relating to concentrations of a contrast agent within given polyhedral volumes of a kinematic system. The storage means comprise instructions that can be executed by processing means implementing a method for estimating a quantity of interest according to the invention when they execute them.

The invention envisages that said processing unit can cooperate with an output device to deliver to the latter an estimated quantity of interest possibly formatted in the form of a content.

In this context, such an output device comprises storage means, a man/machine interface and means to communicate with the outside world cooperating respectively with processing means. According to the invention, the communication means are capable of receiving from the outside world (for example from a processing unit) a quantity of interest relating to a flow of body fluid in an organ based on experimental signals delivered by a tomographic measurement system and relating to concentrations of a contrast agent within given polyhedral volumes. The man/machine interface of such a device is capable of outputting for a user a representation of the quantity of interest. The storage means contain instructions that can be executed by processing means by implementing an output method when they execute them.

If a quantity of interest—relative to a flow of body fluid in an organ based on experimental signals delivered by a tomographic measurement system and relating to the concentrations of a contrast agent within given polyhedral volumes—is estimated then formatted in the form of a content according to the invention, the communication means of said output device are capable of receiving said content from the outside world. The processing means of the device are arranged to read said content and command the man/machine interface so that the latter outputs the representation of the quantity of interest.

A tomographic imaging analysis system comprising a processing unit and an output device, all according to the invention, are also envisaged, said output device cooperating with said processing unit.

An estimation method according to the invention may be advantageously implemented by the processing unit by means of an ad hoc computer program that can be operated by the processing unit and recorded in the storage means by cooperating with the processing means of said processing unit. Such a programme thus contains instructions that can be executed by said processing means by implementing the estimation method when they execute them.

Similarly, the invention envisages a computer program that can be recorded in the storage means by cooperating with the processing means of an output device, said program containing instructions that can be executed by said processing means by implementing an output method according to the invention when they execute them.

Further features and advantages of the invention will emerge from the following description and an examination of the accompanying figures, in which:

FIGS. 1 and 2 (previously described) show two variations of embodiment of a perfusion imaging analysis system;

FIGS. 3 and 4 (previously described) show respectively a perfusion image, obtained by a Nuclear Magnetic Resonance imaging device, of a slice of a human brain before injecting a contrast agent and during the circulation thereof in the tissues of said brain;

FIGS. 5a and 5b (previously described) show a typical perfusion signal s(x,y,z,t) by nuclear magnetic resonance relating to a voxel of a human brain;

FIG. 6 (previously described) shows a typical concentration curve c(x,y,z,t) of a contrast agent circulating within a voxel of a human brain;

FIG. 7 (previously described) shows a typical arterial input function cₐ(t);

FIG. 8 shows an example of a graphic output, delivered by a known output device, of an estimation of the CBF parameter, according to the state of the art, in the form of a choropleth map;

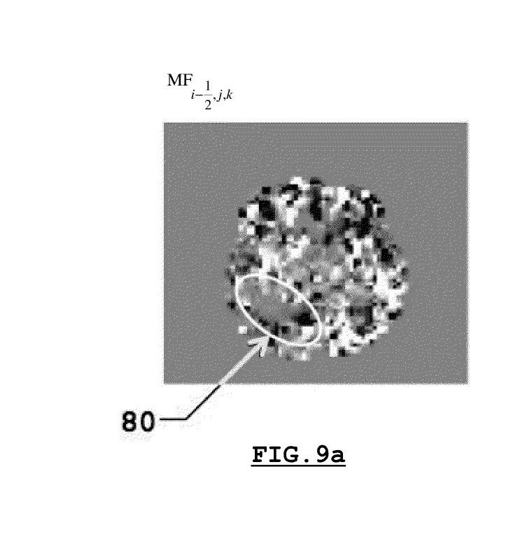

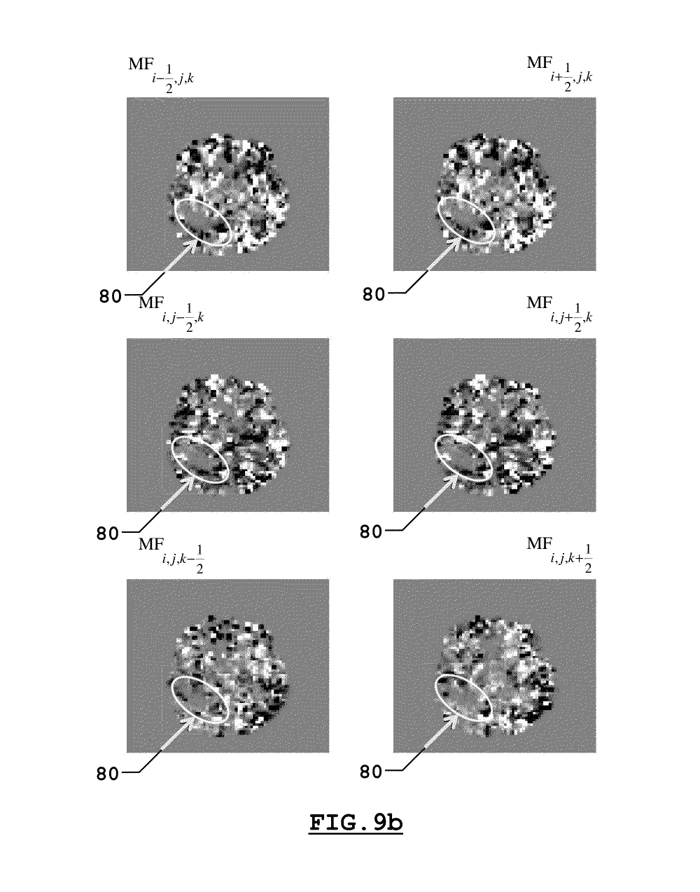

FIG. 9a shows an example of a graphic output, delivered by an output device according to the invention, of an estimation of plasma flow across an oriented face for a set of voxels of interest;

FIG. 9b shows an example of a graphic output, delivered by an output device according to the invention, of an estimation of six plasma flows across each of the six oriented faces for a set of voxels of interest;

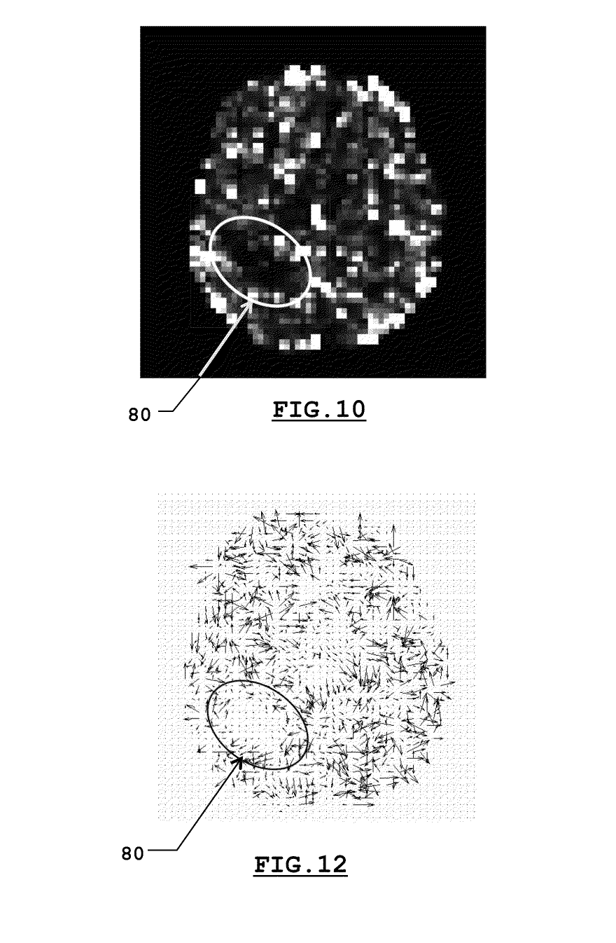

FIG. 10 shows an example of a graphic output, delivered by an output device according to the invention, of the estimation of plasma volumes for a set of voxels of interest;

FIG. 11 shows an example of a graphic output, delivered by an output device according to the invention, of the estimation of the plasma velocities for a set of voxels of interest;

FIG. 12 shows an example of a graphic output, delivered by an output device according to the invention, of the estimation of a plasma velocity vector field for a set of voxels of interest.

As an example of a preferred application and according to the invention, we will begin by establishing the novel local standard models of the kinetics of purely intravascular contrast agents for any contrast agent tomographic measurement technique.

As stated previously, open surfaces on the voxel must be identified a priori in order to define the associated not-necessarily-zero flows. Any surfaces whatsoever may be identified a priori but, just as the voxel is the unit of volume, so are its faces the units of surface in our problem. Let us therefore consider the six faces Fᵢ, i=1,6 of the voxel. Let us give them all an outgoing orientation. Let

$${Φ}_{i}^{v} ( t ) = {\int \int }_{{F}_{i}} \vec{v} ( x , y , z , t ) \cdot \vec{d Σ}$$

be the total volumetric flow across the oriented face Fᵢ at time t. By applying the Green-Ostrogradsky divergence theorem for an incompressible flow and additivity, the total volumetric flow across the closed surface of the voxel

$$Σ = {{⋃}_{i = 1}}^{6} {F}_{i}$$

is written at time t as:

$${Φ}_{Σ}^{v} ( t ) = {Σ}_{} \vec{v} ( x , y , z , t ) \cdot \vec{d Σ} = {\sum }_{i = 1}^{6} {\int \int }_{{F}_{i}} \vec{v} ( x , y , z , t ) \cdot \vec{d Σ} = {\sum }_{i = 1}^{6} {Φ}_{i}^{v} ( t ) = 0$$

Moreover, we also have Φᵢ^{v}(t)=Φᵢ^{IF}(t)+Φᵢ^{EF}(t)+Φᵢ^{BV}(t). Let c(t) be the mass concentration of the contrast agent in the current voxel, V^{P} the plasma subvolume in this voxel, cᵢ(t),i=1,6 the mass concentrations in the six voxels neighbouring the current voxel sharing with it face Fᵢ respectively and lastly Vᵢ^{P},i=1,6 the respective plasma subvolumes in these neighbouring voxels.

The mass balance of the contrast agent in the volume of the voxel of measurement V delimited by Σ is performed as before. Noting mᵢ(t) the signed mass of the contrast agent exiting across face Fᵢ in the interval of time [t,t+∂t] we have:

$$\partial m ( t ) = V \cdot \partial c ( t ) = - {{\sum }_{i = 1}}^{6} {m}_{i} ( t )$$

On the other hand, assuming that as before the contrast agent is uniformly diluted in the fluid that is transporting it, namely the plasma, so that the mass is proportional to the volume, we have:

mᵢ(t)=Vᵢ(t)·cᵢ^{S}(t)=cᵢ^{S}(t)·Φᵢ^{P}(t)·∂t

where Vᵢ(t) is the signed subvolume of plasma fluid exiting across face Fᵢ in the interval of time [t,t+∂t], Φᵢ^{P}(t) is its volumetric flow and cᵢ^{S}(t) the plasma mass concentration of the contrast agent in the immediate neighbourhood of Fᵢ.

All of the surfaces being oriented as outgoing, the flow across a face Fᵢ of one voxel is equal to the opposite of the flow across the same face for the neighbouring voxel sharing this face with this voxel:

Φᵢ(t)_{neighbor}=−Φᵢ(t)_{current}.

As previously described, the local kinetic model is conditional on the six overall directions of flow across each of the six faces or, in an equivalent manner, on the signs of the six volumetric flows across said faces. The outgoing mass concentrations of the contrast agent at faces Fᵢ are therefore written for i=1,6:

$${c}_{i}^{S} ( t ) = \{ \begin{matrix}c ( t ) V / {V}^{P} & iff {Φ}_{i}^{P} ( t ) \geq 0 \\ {c}_{i} ( t ) V / {V}_{i}^{P} & iff {Φ}_{i}^{P} ( t ) < 0\end{matrix}$$

The local kinetic model is therefore written as

$$\frac{\partial c}{\partial t} ( t ) = - \frac{1}{V} \cdot {\sum }_{i = 1}^{6} {Φ}_{i}^{P} ( t ) \cdot {c}_{i}^{S} ( t )$$

If we assume the flow to be permanent only during the signal acquisition duration D, namely ∀i∀t□[0,D], Φᵢ^{P}(t)≡Φᵢ^{P}, we then have a first local kinetic model with seven compartments:

$$\frac{\partial c}{\partial t} ( t ) = - \frac{1}{V} \cdot {\sum }_{i = 1}^{6} {Φ}_{i}^{P} ( t ) \cdot {c}_{i}^{S} ( t ) = - {\sum }_{i = 1}^{6} {Φ}_{i}^{P} \cdot \{ \begin{matrix}c ( t ) / {V}^{P} & iff {Φ}_{i}^{P} ( t ) \geq 0 \\ {c}_{i} ( t ) / {V}_{i}^{P} & iff {Φ}_{i}^{P} ( t ) < 0\end{matrix}$$

whose parameters are, generally speaking, the six plasma volumetric flows Φᵢ^{P},i=1,6 and the seven plasma subvolumes Vᵢ^{P},i=1,6 and V^{P}. Moreover, if we assume the flow to be always permanent, namely ∀i∀t, Φᵢ^{P}(t)≡Φᵢ^{P}, and not infinitely compressible, then the total plasma flow

$${\sum }_{i = 1}^{6} {Φ}_{i}^{P}$$

is necessarily identically zero since the voxel cannot fill up or empty itself indefinitely. We therefore have only five free plasma flows, and a second local kinetic model with seven compartments is written, for example, if we eliminate Φ₆^{P}:

$$\frac{\partial c}{\partial t} ( t ) = - \frac{1}{V} \cdot {\sum }_{i = 1}^{5} {Φ}_{i}^{P} \cdot {c}_{i}^{S} ( t ) + \frac{1}{V} \cdot {c}_{6}^{S} ( t ) \cdot {\sum }_{i = 1}^{5} {Φ}_{i}^{P}$$

The parameters of this model are, generally speaking, the five plasma volumetric flows Φᵢ^{P},i=1,5 and the seven plasma subvolumes Vᵢ^{P},i=1,6 and V^{P}.

This second model relates to a permanent flow in a voxel whereas the Kety type model, as we have established on the basis of Fluid Kinematics, relates to a flow in a pipe whose overall direction is known a priori, for example Φ₁^{P}<0. In fact, if the voxel had only two neighbouring voxels i=1,2, we could very well have c₁^{S}(t)=c₁(t)V/V₁^{P} since Φ₁^{P}<0 and c₂^{S}(t)=c(t)V/V^{P} since Φ₂^{P}=−Φ₁^{P}>0, so that:

$$\frac{\partial c}{\partial t} ( t ) = - {c}_{1} ( t ) {Φ}_{1}^{P} / {V}_{1}^{P} + c ( t ) {Φ}_{1}^{P} / {V}^{P} = - {Φ}_{1}^{P} [ {c}_{1} ( t ) / {V}_{1}^{P} - c ( t ) / {V}^{P} ]$$

These two local models are relevant a priori. If the flow is assumed to be permanent only during the acquisition duration, the absolute value of the total plasma flow

$$\vert {\sum }_{i = 1}^{6} {Φ}_{i}^{P} \vert$$

is a quantity of interest providing a measurement of the non-stationarity of the flow for each voxel of interest.

The local models previously established are all also valid for purely extravascular contrast agents as for purely intrasvascular contrast agents: if the contrast agent is transported solely by the interstitium and is uniformly diluted therein, it is sufficient to replace the volumetric flows and the plasma subvolumes with their interstitial equivalents. Thus, the first local model of the kinematics of a purely extravascular contrast agent is written for example as:

$$\frac{\partial c}{\partial t} ( t ) = - \frac{1}{V} \cdot {\sum }_{i = 1}^{6} {Φ}_{i}^{I} \cdot {c}_{i}^{S} ( t ) = - {\sum }_{i = 1}^{6} {Φ}_{i}^{I} \cdot \{ \begin{matrix}c ( t ) / {V}^{I} & ssi {Φ}_{i}^{I} ( t ) \geq 0 \\ {c}_{i} ( t ) / {V}_{i}^{I} & ssi {Φ}_{i}^{I} ( t ) < 0\end{matrix}$$

whose parameters are, generally speaking, the six interstitial volumetric flows Φᵢ^{I},i=1,6 and the seven interstitial subvolumes Vᵢ^{I},i=1,6 and V^{I}.

More precisely and without loss of generality, let us now index a voxel by its integer coordinates (i,j,k) in the Galilean reference frame (O,\vec{x},\vec{y},\vec{z}). Thus we note c_{i,j,k}(t) as the mass concentration of the contrast agent in this voxel and V_{i,j,k} as the subvolume, plasmatic in intravascular imaging or interstitial in extravascular imaging, in the voxel.

Let us now orient the six faces of the voxel and the corresponding flow along the axes of the reference frame (O,\vec{x},\vec{y},\vec{z}) and index them by their half-integer coordinates (i−½,j,k), (i+½,j,k), (i,j−½,k), (i,k+½,k), (i,j,k−½) and (i,j,k+½). For example, we note

$${Φ}_{i + \frac{1}{2} , j , k}$$

as the stationary volumetric flow across the face of the voxel with coordinates (i,j,k) oriented as outgoing according to the vector \vec{x} and

$${Φ}_{i - \frac{1}{2} , j , k} ,$$

the flow across the face opposite the voxel being oriented according to the same vector \vec{x}, etc.

In this way, the flow across the surface oriented as outgoing according to the vector \vec{x} for the voxel with coordinates (i−1,j,k) is indeed

$${Φ}_{( i - 1 ) + \frac{1}{2} , j , k} = {Φ}_{i - \frac{1}{2} , j , k}$$

accordance with the condition Φᵢ(t)_{neighbor}=−Φᵢ(t)_{current}. Namely α_{i,j,k}=1/V_{i,j,k} and

$$\begin{matrix}\{ \begin{matrix}{c}_{i + \frac{1}{2} , j , k}^{s} ( t ) = \{ \begin{matrix}{c}_{i , j , k} ( t ) V {α}_{i , j , k} & iff {Φ}_{i + \frac{1}{2} , j , k} ( t ) \geq 0 \\ {c}_{i + 1 , j , k} ( t ) V {α}_{i + 1 , j , k} & iff {Φ}_{i + \frac{1}{2} , j , k} ( t ) < 0\end{matrix} \\ {c}_{i - \frac{1}{2} , j , k}^{s} ( t ) = \{ \begin{matrix}{c}_{i , j , k} ( t ) V {α}_{i , j , k} & iff {Φ}_{i - \frac{1}{2} , j , k} ( t ) < 0 \\ {c}_{i - 1 , j , k} ( t ) V {α}_{i - 1 , j , k} & iff {Φ}_{i + \frac{1}{2} , j , k} ( t ) \geq 0\end{matrix} \\ {c}_{i , j + \frac{1}{2} , k}^{s} ( t ) = \{ \begin{matrix}{c}_{i , j , k} ( t ) V {α}_{i , j , k} & iff {Φ}_{i , j + \frac{1}{2} , k} ( t ) \geq 0 \\ {c}_{i , j + 1 , k} ( t ) V {α}_{i , j + 1 , k} & iff {Φ}_{i , j + \frac{1}{2} , k} ( t ) < 0\end{matrix} \\ {c}_{i , j - \frac{1}{2} , k}^{s} ( t ) = \{ \begin{matrix}{c}_{i , j , k} ( t ) V {α}_{i , j , k} & iff {Φ}_{i , j - \frac{1}{2} , k} ( t ) < 0 \\ {c}_{i , j - 1 , k} ( t ) V {α}_{i , j - 1 , k} & iff {Φ}_{i , j - \frac{1}{2} , k} ( t ) \geq 0\end{matrix} \\ {c}_{i , j , k + \frac{1}{2}}^{s} ( t ) = \{ \begin{matrix}{c}_{i , j , k} ( t ) V {α}_{i , j , k} & iff {Φ}_{i , j , k + \frac{1}{2}} ( t ) \geq 0 \\ {c}_{i , j , k + 1} ( t ) V {α}_{i , j , k + 1} & iff {Φ}_{i , j , k + \frac{1}{2}} ( t ) < 0\end{matrix} \\ {c}_{i , j , k - \frac{1}{2}}^{s} ( t ) = \{ \begin{matrix}{c}_{i , j , k} ( t ) V {α}_{i , j , k} & iff {Φ}_{i , j , k - \frac{1}{2}} ( t ) < 0 \\ {c}_{i , j , k - 1} ( t ) V {α}_{i , j , k - 1} & iff {Φ}_{i , j , k - \frac{1}{2}} ( t ) \geq 0\end{matrix}\end{matrix} & \end{matrix}$$

With this new orientation convention, the first local kinetic model

$$\frac{\partial c}{\partial t} ( t ) = - \frac{1}{V} \cdot {\sum }_{i = 1}^{6} {Φ}_{i}^{P} \cdot {c}_{i}^{s} ( t ) = - {\sum }_{i = 1}^{6} {Φ}_{i}^{P} \cdot \{ \begin{matrix}c ( t ) / {V}^{P} & iff {Φ}_{i}^{P} ( t ) > 0 \\ {c}_{i} ( t ) / {V}_{i}^{P} & iff {Φ}_{i}^{P} ( t ) < 0\end{matrix}$$

should be rewritten as

$$\frac{\partial {c}_{i , j , k}}{\partial t} ( t ) = - \frac{1}{V} \cdot \{ \begin{matrix}{Φ}_{i + \frac{1}{2} , j , k} {c}_{i + \frac{1}{2} , j , k}^{s} ( t ) - {Φ}_{i - \frac{1}{2} , j , k} {c}_{i - \frac{1}{2} , j , k}^{s} ( t ) + \\ {Φ}_{i , j + \frac{1}{2} , k} {c}_{i , j + \frac{1}{2} , k}^{s} ( t ) - {Φ}_{i , j - \frac{1}{2} , k} {c}_{i , j - \frac{1}{2} , k}^{s} ( t ) + \\ {Φ}_{i , j , k + \frac{1}{2}} {c}_{i , j , k + \frac{1}{2}}^{s} ( t ) - {Φ}_{i , j , k - \frac{1}{2}} {c}_{i , j , k - \frac{1}{2}}^{s} ( t )\end{matrix} \}$$

for each of the voxels of coordinates (i,j,k) having six neighbouring voxels, which we shall call interior voxels. Similarly, if the flows

$${Φ}_{i , j , k + \frac{1}{2}}$$

are eliminated, the second local kinetic model

$$\frac{\partial c}{\partial t} ( t ) = - \frac{1}{V} \cdot {\sum }_{i = 1}^{5} {Φ}_{i}^{P} \cdot {c}_{i}^{s} ( t ) + \frac{1}{V} \cdot {c}_{6}^{s} ( t ) \cdot {\sum }_{i = 1}^{5} {Φ}_{i}^{P}$$

should be rewritten as

$$\frac{\partial {c}_{i , j , k}}{\partial t} ( t ) = - \frac{1}{V} \cdot [ \begin{matrix}\begin{matrix}\begin{matrix}{Φ}_{i + \frac{1}{2} , j , k} {c}_{i + \frac{1}{2} , j , k}^{s} ( t ) - {Φ}_{i - \frac{1}{2} , j , k} {c}_{i - \frac{1}{2} , j , k}^{s} ( t ) + \\ {Φ}_{i , j + \frac{1}{2} , k} {c}_{i , j + \frac{1}{2} , k}^{s} ( t ) - {Φ}_{i , j - \frac{1}{2} , k} {c}_{i , j - \frac{1}{2} , k}^{s} ( t ) +\end{matrix} \\ ( \begin{matrix}{Φ}_{i , j , k - \frac{1}{2}} - {Φ}_{i + \frac{1}{2} , j , k} + \\ {Φ}_{i - \frac{1}{2} , j , k} - {Φ}_{i , j + \frac{1}{2} , k} + {Φ}_{i , j - \frac{1}{2} , k}\end{matrix} ) {c}_{i , j , k + \frac{1}{2}}^{s} ( t ) -\end{matrix} \\ {Φ}_{i , j , k - \frac{1}{2 }} {c}_{i , j , k - \frac{1}{2}}^{s} ( t )\end{matrix} ]$$

or as

$$\frac{\partial {c}_{i , j , k}}{\partial t} ( t ) = - \frac{1}{V} \cdot \{ \begin{matrix}\begin{matrix}{Φ}_{i + \frac{1}{2} , j , k} [ {c}_{i + \frac{1}{2} , j , k}^{s} ( t ) - {c}_{i , j , k + \frac{1}{2}}^{s} ( t ) ] - \\ {Φ}_{i - \frac{1}{2} , j , k} [ {c}_{i - \frac{1}{2} , j , k}^{s} ( t ) - {c}_{i , j , k + \frac{1}{2}}^{s} ( t ) ] +\end{matrix} \\ \begin{matrix}{Φ}_{i , j + \frac{1}{2} , k} [ {c}_{i , j + \frac{1}{2} , k}^{s} ( t ) - {c}_{i , j , k + \frac{1}{2}}^{s} ( t ) ] - \\ {Φ}_{i , j - \frac{1}{2} , k} [ {c}_{i , j - \frac{1}{2} , k}^{s} ( t ) - {c}_{i , j , k + \frac{1}{2}}^{s} ( t ) ] -\end{matrix} \\ {Φ}_{i , j , k - \frac{1}{2}} [ {c}_{i , j , k - \frac{1}{2}}^{s} ( t ) - {c}_{i , j , k + \frac{1}{2}}^{s} ( t ) ]\end{matrix} \}$$

For exterior voxels, namely those having more than five neighbouring voxels, there are two possible scenarios:
either we know a priori, for example thanks to anatomy, that all of the flows across each of the faces where the exterior voxel has no neighbour are necessarily zero. We call these interior voxels border voxels. In this case we have equations similar to those for interior voxels but with certain zero flows. For example, for a border voxel with no neighbour (i−1,j,k), (i,j−1,k) and (i,j,k−1) (i.e. located in a corner of the volume imaged), we will have for example the reduced-form equation for the second local model

$$\frac{\partial {c}_{i , j , k}}{\partial t} ( t ) = - \frac{1}{V} \cdot [ \begin{matrix}{Φ}_{i + \frac{1}{2} , j , k} {c}_{i + \frac{1}{2} , j , k}^{s} ( t ) + {Φ}_{i , j + \frac{1}{2} , k} {c}_{i , j + \frac{1}{2} , k}^{s} ( t ) - \\ ( {Φ}_{i + \frac{1}{2} , j , k} + {Φ}_{i , j + \frac{1}{2} , k} ) {c}_{i , j , k + \frac{1}{2}}^{s} ( t )\end{matrix} ]$$

or at least one flow across a face where the exterior voxel has no neighbouring voxel is not necessarily zero or at least known a priori. In this case, there is no equation for this exterior voxel because the resulting system of equations would then be underdetermined. Only the concentration of the contrast agent c_{i,j,k}(t) in this voxel would be included in the system of equations, as neighbouring voxels of this voxel, interior or border. These non-border exterior voxels therefore play the role of inputs or outputs in the kinematic system. They could be said to be, for the entire imaged kinematic system, the three-dimensional analogs of the arterial input functions and venous output functions for each voxel of state-of-the-art perfusion and permeability models.

For the two local models previously described, the local equations for all of the interior and border voxels with fixed volumetric flows constitute a first order linear inhomogeneous ordinary differential equation system with constant coefficients. It can be put in the matrix format

$$\frac{\partial c}{\partial t} ( t ) = A \cdot c ( t ) + {b}_{E} ( t )$$

where c(t) is the vector of all of the concentrations at time t in the interior or border voxels, b_{E}(t) is the corresponding vector for the non-border exterior voxels and A is a sparse symmetric matrix whose coefficients depend on the volumetric flows, subvolumes and geometry of the imaged volume. The analytical solution of this system with initial condition c(t₀)=c₀ is given by:

$$c ( t ) = {e}^{A ( t - {t}_{0} )} \cdot {c}_{0} + {e}^{A ( t - {t}_{0} )} \cdot {\int }_{{t}_{0}}^{t} {e}^{- A ( τ - {t}_{0} )} \cdot {b}_{E} ( τ ) d τ .$$

In particular, if c₀=0, we have:

$$c ( t ) = {e}^{A ( t - {t}_{0} )} \cdot {\int }_{{t}_{0}}^{t} {e}^{- A ( τ - {t}_{0} )} \cdot {b}_{E} ( τ ) d τ = {\int }_{{t}_{0}}^{t} {e}^{A ( t - τ )} \cdot {b}_{E} ( τ ) d τ = {e}^{At} ⊗ {b}_{E}$$

We recognise a monoexponential, integral Kety type global kinetic model, but with a matrix structure and three-dimensional.

These analytical solutions constitute respectively the two global models of the kinetics of purely intravascular or purely extravascular contrast agents according to the invention, as deduced by the strict application of the Principle of Conservation of Mass.

Unlike state-of-the-art models that describe the kinetics of a contrast agent in each voxel completely independently of the other voxels, as if there were no circulation from one voxel to another but only through obscure and virtual local but not localised venous output and arterial input functions, the local and global models according to the invention are based on the Principle of Locality of Classic Physics which stipulates that a system is only influenced by its immediate neighbourhood and that consequently the circulation in one voxel necessarily occurs across the six neighbouring voxels of said voxel (at the most). In other words, to use the established terminology, said models are based on the fact that the arterial input and the venous output of a voxel can in fact only consist of the concentration curves in the six neighbouring voxels. In short, whoever says voxel says six faces, therefore six flows (across each face of said voxel) and therefore six arterial input functions (AIF) or venous output functions (VOF).

Generally speaking, the invention applies to any paving by polyhedral volumes of the imaged volume. We therefore have at least four flows and four AIF/VOF per polyhedron in the case of a tetrahedral volume comprising four flat faces.

Whereas the state-of-the-art models are merely perfusion and permeability models in each local volumetric element such as a parallelepiped voxel, so that it would not be true to refer to them as having a spatial dimension, the global kinetic models according to the invention describe the circulation in the entire three-dimensional volume of interest determined by all of these volumetric elements. Thus the invention finally enables the implementation of tomography techniques using a three-dimensional contrast agent.

Let us now examine the general case of the kinematics of an intravascular and extravascular contrast agent. Just after its injection, the contrast agent is initially transported by the intravascular plasma as it first passes into a polyhedral volume (for example a voxel). Subsequently, its plasma concentration falls by excretion while part of it passes from the intravascular medium into the extravascular medium, i.e. into the interstitial fluid. First of all, we therefore have an intravascular phase where the fluid transporting the contrast agent is plasma (wash-in) followed by an extravascular phase where the fluid transporting the contrast agent becomes the interstitium (wash-out), possibly followed by a phase where some of the contrast agent passes back from the extravascular environment into the intravascular environment.

We still have

$$\partial m ( t ) = V \cdot \partial c ( t ) = - {\sum }_{i = 1}^{6} {m}_{i} ( t )$$

but now with mᵢ(t)=mᵢ^{P}(t)+mᵢ^{I}(t) where mᵢ^{I}(t) is the mass of the contrast agent transported by the interstitium exiting across face Fᵢ during the time lapse [t,t+∂t]. We still have mᵢ^{P}(t)=cᵢ^{S,P}(t)·Φᵢ^{P}(t)·∂t and

$${c}_{i}^{S , P} ( t ) = \{ \begin{matrix}{c}^{P} ( t ) & iff {Φ}_{i}^{P} ( t ) \geq 0 \\ {c}_{i}^{P} ( t ) & iff {Φ}_{i}^{P} ( t ) < 0\end{matrix}$$

if the contrast agent is uniformly diluted in the plasma. Similarly mᵢ^{I}(t)=cᵢ^{S,I}(t)·Φᵢ^{I}(t)·∂(t) with

$${c}_{i}^{S , I} ( t ) = \{ \begin{matrix}{c}^{I} ( t ) & iff {Φ}_{i}^{I} ( t ) > 0 \\ {c}_{i}^{I} ( t ) & iff {Φ}_{i}^{I} ( t ) < 0\end{matrix}$$

if the contrast agent is also uniformly diluted in the interstitium.

At time t, the total mass of the contrast agent in the voxel is m(t)=c(t)V=m^{P}(t)+m^{I}(t)=c^{P}(t)V^{P}+c^{I}(t)V^{I}.

Ignoring the volume of the vessels compared to the intravascular and extravascular volumes, we have V=V^{IF}+V^{EF}=V^{P}(t)+V^{C}(t)+V^{I}(t)+V^{EC}(t) where V^{I}(t) is the interstitial subvolume and V^{EC}(t) is the extravascular cell subvolume.

Assuming the volumetric fractions of hematocrite V^{C}(t)/V^{I}≡ρ^{P} and interstitial V^{EC}(t)/V^{EF}≡ρ^{I} to be constant, we have

$$\{ \begin{matrix}{c}^{P} ( t ) = [ c ( t ) V - {c}^{I} ( t ) {V}^{I} ] / [ V - {V}^{I} / ( 1 - {ρ}^{I} ) ] / ( 1 - {ρ}^{P} ) \\ {c}_{i}^{P} ( t ) = [ {c}_{i} ( t ) V - {c}_{i}^{I} ( t ) {V}_{i}^{I} ] / [ V - {V}_{i}^{I} / ( 1 - {ρ}^{I} ) ] / ( 1 - {ρ}^{P} )\end{matrix}$$

so that we have the first local kinetic model

$$\begin{matrix}\frac{\partial c}{\partial t} ( t ) = - \frac{1}{V} {\sum }_{i = 1}^{6} {c}_{i}^{S , P} ( t ) {Φ}_{i}^{P} ( t ) + {c}_{i}^{S , I} ( t ) {Φ}_{i}^{I} ( t ) \\ = - \frac{1}{V} {\sum }_{i = 1}^{6} {Φ}_{i}^{P} ( t ) \{ \begin{matrix}{c}^{P} ( t ) & ssi {Φ}_{i}^{P} ( t ) \geq 0 \\ {c}_{i}^{P} ( t ) & ssi {Φ}_{i}^{P} ( t ) < 0\end{matrix} \} + \\ {Φ}_{i}^{I} ( t ) \{ \begin{matrix}{c}^{I} ( t ) & iff {Φ}_{i}^{I} ( t ) \geq 0 \\ {c}_{i}^{I} ( t ) & iff {Φ}_{i}^{I} ( t ) < 0\end{matrix} \} \\ = - \frac{1}{V} {\sum }_{i = 1}^{6} {Φ}_{i}^{P} ( t ) \{ \begin{matrix}\frac{[ c ( t ) V - {c}^{I} ( t ) {V}^{I} ]}{\frac{[ V - {V}^{I} / ( 1 - {ρ}^{I} ) ]}{( 1 - {ρ}^{P} )}} & iff {Φ}_{i}^{P} ( t ) \geq 0 \\ \frac{[ {c}_{i} ( t ) V - {c}_{i}^{I} ( t ) {V}_{i}^{I} ]}{\frac{[ V - {V}_{i}^{I} / ( 1 - {ρ}^{I} ) ]}{( 1 - {ρ}^{P} )}} & iff {Φ}_{i}^{P} ( t ) < 0\end{matrix} \} + \\ {Φ}_{i}^{I} ( t ) \{ \begin{matrix}{c}^{I} ( t ) & iff {Φ}_{i}^{I} ( t ) \geq 0 \\ {c}_{i}^{I} ( t ) & iff {Φ}_{i}^{I} ( t ) < 0\end{matrix} \}\end{matrix}$$

Assuming that the flow is always permanent, the total interstitial and plasma volumetric flows cancel each other out and we will have only five plasma volumetric flows and five free interstitial volumetric flows, satisfying for example, if we eliminate the sixth volumetric flows, the second local kinematic model:

$$\begin{matrix}\frac{\partial c}{\partial t} ( t ) = - \frac{1}{V} {\sum }_{i = 1}^{6} {c}_{i}^{S , P} ( t ) {Φ}_{i}^{P} ( t ) + {c}_{i}^{S , I} ( t ) {Φ}_{i}^{I} ( t ) \\ = - \frac{1}{V} {{\sum }_{i = 1}}^{5} {c}_{i}^{S , P} ( t ) {Φ}_{i}^{P} ( t ) + {c}_{i}^{S , I} ( t ) {Φ}_{i}^{I} ( t ) + \frac{1}{V} {c}_{6}^{S , P} ( t ) {\sum }_{i = 1}^{5} {Φ}_{i}^{P} ( t ) + \\ \frac{1}{V} {c}_{6}^{S , I} ( t ) {\sum }_{i = 1}^{5} {Φ}_{i}^{I} ( t )\end{matrix}$$

Note that in all cases, the equations now include the unknown interstitial (or plasma) mass concentration curves plus the mass concentration curves in the voxels. Generally speaking, it is therefore necessary to add information or equations enabling the plasma and interstitial components to be separated. Since all we need to do here is to express the Principle of Conservation of Mass, we shall go no further.

However, the models of the kinetics of purely extravascular contrast agents described previously can apply to permeability imaging data (e.g. DCE-MR) from the moment that the intravascular and extravascular phases can be separated. This is the case, for example for organs that have an intra/extravascular barrier such as the brain. In fact, the end of the intravascular phase can be determined as the shortest time t at which the the concentration curves, provided the barrier is not ruptured, return to zero. We can then apply an extravascular kinematic model to the concentration curves where there is a rupture of the barrier in the interval of time [t,+∞] in order to determine extravascular flows and subvolumes.

In any case, we can always stop trying to separate the intravascular and extravascular components and work with the compound plasma and interstitial subvolumes and flows Φᵢ^{P∪I} and Vᵢ^{P∪I} which, under the same hypotheses as before, satisfy for example the first local kinematic model

$$\frac{\partial c}{\partial t} ( t ) = - \frac{1}{V} {\sum }_{i = 1}^{6} {Φ}_{i}^{P ⋃ I} {c}_{i}^{s} ( t )$$

with

$${c}_{i}^{s} ( t ) = \{ \begin{matrix}c ( t ) V / {V}^{P ⋃ I} & iff {Φ}_{i}^{P ⋃ I} ( t ) \geq 0 \\ {c}_{i} ( t ) V / {V}_{i}^{P ⋃ I} & iff {Φ}_{i}^{P ⋃ I} ( t ) < 0\end{matrix} .$$

Assuming the volumetric fractions of hematocrite and interstitial to be constant in space, the compound subvolumes Vᵢ^{P∪I} are constant throughout so that only volumetric flows Φᵢ^{P∪I} need to be estimated.

The invention allows us to estimate the parameters of the three-dimensional kinetic models described previously, namely the volumetric flows Φ={Φ_{.,.,.}}, the subvolumes of fluid transporting the contrast agent or their inverses α={α_{.,.,.}} and the time t₀ (or only (Φ,t₀) if the plasma and interstitial compound subvolume Vᵢ^{P∪I} are assumed to be constant). Strictly speaking, the continuous time analytical models previously obtained in discrete time models should advantageously first be transformed since the concentrations are sampled on time grids. In particular, we should address the case where these samples are in fact time integrals of concentrations over the sampling period (flow data to use econometric terminology). For the sake of brevity, we shall ignore this step in what follows and assume as is customary that the simple discretisation of a continuous time model provides a proper approximation of a discrete time model.

We should also mention that the vector of flows Φ and the vector of the inverses of volumes α are globally underdetermined to a close multiplicative constant since the global kinetic models are invariants by the transformation

$$( Φ , α ) ↦ ( λ Φ , \frac{α}{λ} )$$

for all λ≠0. In order to set λ in intravascular tomography, it is particularly advantageous to constrain the plasma subvolume in the voxels which we know a priori contain blood only by

$${V}_{ma x}^{P} = \frac{1}{{α}_{m i n}} = ( 1 - {Ht}^{′} ) \cdot {V}^{IF} = ( 1 - {Ht}^{′} ) \cdot V$$

where

$${Ht}^{′} ≡ \frac{{V}^{C}}{{V}^{BV}}$$

is the fraction of hematocrite assumed to be everywhere and always constant. The same approach can be adopted towards extravascular tomography by constraining the interstitial volume in at least one voxel that we know a priori contains no blood.

It is assumed that a parametric model M exists linking the theoretical tomographic signal s_{i,j,k}(t) to the mass concentration of the contrast agent c_{i,j,k}(t) in the voxel of coordinates (i,j,k) so that M: s_{i,j,k}(t)=f[c_{i,j,k}(t),Θ_{i,j,k}] where Θ_{i,j,k} is the vector of the unknown parameters of the model to be estimated.

For example, as previously described, typically we have M: s_{i,j,k}(t)=kc_{i,j,k}(t)+s_{i,j,k}⁰, Θ=s_{i,j,k}⁰ in computed tomography perfusion and M: s_{i,j,k}(t)=s_{i,j,k}⁰e^{-k·TE·c}^{_{i,j,k}}^{(t)}, Θ=s_{i,j,k}⁰ in DSC-MR, the unknown constants k being fixed once and for all. A global theoretical model of the tomographic signals s_{i,j,k}(t) is thus obtained. Clearly, strictly speaking, we should adjust this model to the measured experimental signals, and not adjust the model of the concentration curves to the “experimental” concentration curves obtained after converting these experimental signals. However, for the sake of brevity, we shall deal with the problem of adjustment of experimental concentration curves later on, given that the adjustment of measured signals is performed in a similar way.

Assuming, for example, the measurement noise on the experimental concentration curves to be additive, we therefore have a global model of the experimental concentration curves in the interior and border voxels c^{exp}(t)=c(t)+ξ(t) where ξ(t) is the vector of the measurement noise at time t. The adjustment of the analytical solution c(t) as described previously at the experimental concentration curves c^{exp}(t) for all of the interior and border voxels can be made conventionally by applying the Bayes method or the maximum likelihood method.

The invention advantageously recommends using the Bayes method because, in addition to permissible estimators of the parameters such as the minimum variance Bayes estimator, it allows additional quantities of interest to be obtained such as their joint and marginal subsequent probability distributions, confidence intervals on these estimations, odds bets on these confidence intervals and lastly the probability of the models by knowing the perfusion or permeability data. Moreover, strictly speaking, the theoretical concentration curves should be jointly estimated in a non-parametric way on the basis of the experimental concentration curves in the non-border exterior voxels, which can only be done accurately by applying the Bayes method.

We note Θ as being the set of all the parameters of the global model of experimental signals, including in particular all of the volumetric flows and all of the plasma subvolumes, and θεΘ as being a quantity of interest among these parameters. The Bayes estimator of minimum variance \hat{θ} of θ is obtained by

$$\hat{θ} = {\int }_{θ} p ( θ \vert {s}^{e xp} ( t ) ) d θ = {\int }_{θ} {\int }_{Θ \backslash θ} p ( Θ \vert {s}^{ex p} ( t ) ) d Θ d θ$$

where s^{exp}(t) is the vector of all of the experimental signals in the kinematic system of interest.

We can see that the estimation of a quantity of interest requires the evaluation of a very large multiple integral (the current maximum spatial resolution in computed tomography perfusion is 512×512×320=84×10⁶, the cardinal of Θ being roughly speaking proportional to the number of voxels). Given their size, the evaluation of these integrals may require a processing unit comprising dedicated software and hardware, mainly to satisfy the constraints of calculation time.

The invention also concerns two particularly suitable embodiments of a method for producing an estimation of a quantity of interest such as a volumetric flux or a subvolume relating to a flow of fluid in a kinematic system based on experimental signals delivered by a tomographic measurement system and relating to the concentrations of a contrast agent within given polyhedral volumes. Said method is implemented by a processing unit such as unit 4, described in connection with FIGS. 1 and 2. Said method includes a step to estimate said quantity of interest based on a kinematic and parametric model comprising a plurality of parameters including a flow across a face of one of said given polyhedral volumes.

According to a first embodiment of the invention whose implementation by a processing unit is particularly easy, if the measurement noises ξ(t) are additive, white, stationary, homoscedastic, uncorrelated and Gaussian, the step to estimate a quantity of interest according to the posterior maximum, maximum likelihood or non-linear least squared method consists in determining the global minimum on (Φ,α,t₀) (or possibly (Φ,t₀)) of a function such as

$${χ}^{2} ( Φ , α , {t}_{0} ) = {\sum }_{( i , j , k )} {\sum }_{l = 1}^{N} {[ {c}_{i , j , k}^{ex p} ( {t}_{l} ) - {c}_{i , j , k} ( {t}_{l} ) ]}^{2}$$

for non-linear least squares where c_{i,j,k}^{exp}(tₗ),l=1,N are the experimental measurements of the concentration of the contrast agent in the interior or border volumetric element of coordinates (i,j,k) and tₗ,l=1,N are the measurement times.

Function χ²(Φ,α,t₀)is non-linear in Φ flows and the subvolumes or their inverses α, which are, as stated previously, potentially very numerous. The minimisation of this function could be problematic in practice if it were not sparse: if the polyhedral volumes are parallelepiped voxels, each flow is involved at most in the equations for two voxels and each subvolume is involved at most in the equations for seven voxels, not in each equation for each voxel. Only time t₀ is involved in all of the equations. However, its estimation does not pose a problem since it is a discrete parameter that has a moderate number of possible values. Yet, very effective methods exist that are dedicated to minimising sparse non-linear functions of a large number of variables such as the large-scale sparse nonlinear least squares methods. The minimisation of χ²(Φ,α,t₀) can then be performed in practice by a processing unit without the calculation time being prohibitive by using suitable digital methods.

However, a second embodiment of the invention can make the step of estimating a quantity of interest even easier. Thus, for a given calculation time, this embodiment allows the necessary material resources of the processing unit to be optimised by implementing the method relating to another embodiment of the invention such as the one previously described. Conversely, for given material resources, the adapted processing unit according to this second embodiment allows the calculation time required for estimating the quantity of interest to be optimised.

To do this it is simply a matter of not analytically integrating the differential system obtained from local kinetic models for all of the interior or border voxels. We begin by rewriting the local differential equations in an integral form.

Assuming that ∀(i,j,k), c_{i,j,k}(t₀)=0, we have for example the second local kinetic model:

$${c}_{i , j , k} ( t ) = - \frac{1}{V} \{ \begin{matrix}\begin{matrix}\begin{matrix}\begin{matrix}{Φ}_{i + \frac{1}{2} , j , k} [ {C}_{i + \frac{1}{2} , j , k}^{S} ( t ) - {C}_{i , j , k + \frac{1}{2}}^{S} ( t ) ] - \\ {Φ}_{i - \frac{1}{2} , j , k} [ {C}_{i - \frac{1}{2} , j , k}^{S} ( t ) - {C}_{i , j , k + \frac{1}{2}}^{S} ( t ) ] +\end{matrix} \\ {Φ}_{i , j + \frac{1}{2} , k} [ {C}_{i , j + \frac{1}{2} , k}^{S} - {C}_{i , j , k + \frac{1}{2}}^{S} ( t ) ] -\end{matrix} \\ {Φ}_{i , j - \frac{1}{2} , k} [ {C}_{i , j - \frac{1}{2} , k}^{S} ( t ) - {C}_{i , j , k + \frac{1}{2}}^{S} ( t ) ] -\end{matrix} \\ {Φ}_{i , j , k - \frac{1}{2}} [ {C}_{i , j , k - \frac{1}{2}}^{S} ( t ) - {C}_{i , j , k + \frac{1}{2}}^{S} ( t ) ]\end{matrix} \}$$

where

$${C}_{. , . , .}^{S} ( t ) ≡ {\int }_{{t}_{0}}^{t} {c}_{. , . , .}^{S} ( τ ) d τ .$$

By then replacing in the right-hand expression the theoretical primitives C_{i,j,k}(t) with their experimental analogs

$${C}_{i , j , k}^{S , ex p} ( t ) ≡ {\int }_{{t}_{0}}^{t} {c}_{i , j , k}^{S , e xp} ( τ ) d τ ,$$

we obtain a model (or more precisely a pseudo-model) for the theoretical concentration curves:

$${c}_{i , j , k} ( t ) = - \frac{1}{V} \cdot \{ \begin{matrix}\begin{matrix}\begin{matrix}\begin{matrix}{Φ}_{i + \frac{1}{2} , j , k} [ {C}_{i + \frac{1}{2} , j , k}^{S , ex p} ( t ) - {C}_{i , j , k + \frac{1}{2}}^{S , ex p} ( t ) ] - \\ {Φ}_{i - \frac{1}{2} , j , k} [ {C}_{i - \frac{1}{2} , j , k}^{S , ex p} ( t ) - {C}_{i , j , k + \frac{1}{2}}^{S , ex p} ( t ) ] +\end{matrix} \\ {Φ}_{i , j + \frac{1}{2} , k} [ {C}_{i , j + \frac{1}{2} , k}^{S , ex p} - {C}_{i , j , k + \frac{1}{2}}^{S , ex p} ( t ) ] -\end{matrix} \\ {Φ}_{i , j - \frac{1}{2} , k} [ {C}_{i , j - \frac{1}{2} , k}^{S , ex p} ( t ) - {C}_{i , j , k + \frac{1}{2}}^{S , ex p} ( t ) ] -\end{matrix} \\ {Φ}_{i , j , k - \frac{1}{2}} [ {C}_{i , j , k - \frac{1}{2}}^{S , ex p} ( t ) - {C}_{i , j , k + \frac{1}{2}}^{S , ex p} ( t ) ]\end{matrix} \}$$

Compared to analytical kinetic models that are nonlinear in all their parameters, these models have the advantage of being piecewise bilinear in the volumetric flows Φ and the inverses of subvolumes α in the sense that:
with set α_{i,j,k} values, they are piecewise linear in the flows;
with set volumetric flows, they are linear in the α_{i,j,k} values.

If the measurement noise ξ(t) is assumed to be additive, white, stationary, homoscedastic, uncorrelated and Gaussian, the step of estimating the quantity of interest of a method according to this second embodiment comprises:
a substep involving, at set t₀, producing an estimator of the least squares Φ^{LS}(α) of the volumetric flows as a function of the α values by resolving the linear system obtained by cancelling out for example the partial derivatives

$$\frac{\partial {χ}^{2}}{\partial {Φ}_{. , . , .}} of$$

$${χ}^{2} ( Φ , α , {t}_{0} ) = {\sum }_{( i , j , k )} {\sum }_{i = 1}^{N} {\{ \begin{matrix}\begin{matrix}\begin{matrix}\begin{matrix}V \cdot {c}_{i , j , k}^{ex p} ( {t}_{l} ) + \\ {Φ}_{i + \frac{1}{2} , j , k} [ {C}_{i + \frac{1}{2} , j , k}^{S , ex p} ( t ) - {C}_{i , j , k + \frac{1}{2}}^{S , ex p} ( t ) ] - \\ {Φ}_{i - \frac{1}{2} , j , k} [ {C}_{i - \frac{1}{2} , j , k}^{S , ex p} ( t ) - {C}_{i , j , k + \frac{1}{2}}^{S , ex p} ( t ) ] +\end{matrix} \\ {Φ}_{i , j + \frac{1}{2} , k} [ {C}_{i , j + \frac{1}{2} , k}^{S , ex p} - {C}_{i , j , k + \frac{1}{2}}^{S , ex p} ( t ) ] -\end{matrix} \\ {Φ}_{i , j - \frac{1}{2} , k} [ {C}_{i , j - \frac{1}{2} , k}^{S , ex p} ( t ) - {C}_{i , j , k + \frac{1}{2}}^{S , ex p} ( t ) ] -\end{matrix} \\ {Φ}_{i , j , k - \frac{1}{2}} [ {C}_{i , j , k - \frac{1}{2}}^{S , ex p} ( t ) - {C}_{i , j , k + \frac{1}{2}}^{S , ex p} ( t ) ]\end{matrix} \}}^{2}$$

within the second local kinetic model.
a substep involving, at set t₀, producing the estimator of the linear least squares α^{LS}(Φ) of the α values as a function of the φ values by resolving the linear system obtained by cancelling out the partial derivatives

$$\frac{\partial {χ}^{2}}{\partial α … ,} .$$

The step of estimating the quantity of interest then involves implementing by means of the processing unit an iterative alternating linear least squares method of the type:

$$For each {t}_{l} , l = 1 , n \\ \vert \begin{matrix}( {t}_{l} ) ← {α}_{0} \\ Repeat \\ \vert \begin{matrix}Φ ( {t}_{l} ) ← {Φ}^{LS} [ α ( {t}_{l} ) ] \\ α ( {t}_{l} ) ← {α}^{LS} [ Φ ( {t}_{l} ) ]\end{matrix} \\ until [ Φ ( {t}_{l} ) , α ( {t}_{l} ) ] converges \\ Calculate {χ}^{2} [ Φ ( {t}_{l} ) , α ( {t}_{l} ) , {t}_{l} ]\end{matrix}$$

$$Estimate ( Φ , α , {t}_{0} ) by {argmin}_{l = 1 , n} {χ}^{2} [ Φ ( {t}_{l} ) , α ( {t}_{l} ) , {t}_{l} ]$$

whereby the convergence towards a local minimum of χ²(Φ,α,t₀) is proven.

In practice, the major problem lies in the step of estimating the volumetric flows by means of Φ(tₗ)←Φ^{LS}[tₗ)]. In fact, by cancelling out the partial derivatives

$$\frac{\partial {χ}^{2}}{\partial Φ … ,} ,$$

we have for each flow Φ_{.,.,.} two possible conditions:

$$\frac{\partial {χ}^{2}}{\partial Φ … ,} = 0$$

with Φ_{.,.,.}≧0,

$$\frac{\partial {χ}^{2}}{\partial Φ … ,} = 0$$

with Φ_{.,.,.}<0.

Thus, for each value of tₗ, the step of estimating the flows Φ by the linear least squares piecewise method strictly speaking requires the resolution of 2^{N}^{_{Φ}} systems of linear normal equations where N_{Φ} is the number of volumetric flows to be estimated. Clearly, this is impossible to do in practice, even for a moderate number of flows. In order to overcome this difficulty, a step according to the invention may then consist in determining beforehand an appropriate global kinetic submodel among the 2^{N}^{_{Φ}} possible submodels based on the signs of the N_{Φ} volumetric flows.

To achieve this, according to a first variation of this embodiment, we estimate in the first instance the sign of each flow, by adjusting the local kinetic models for all of the interior and border volume elements. We have, for example, according to the signs of the local volumetric flows exiting across each face of a current voxel, at most 2⁶=64 possible submodels of the kinetics in this voxel. For example, if all of the flows are incoming we have, in the context of the first local kinetic model, the local submodel

$$\frac{\partial {c}_{i , j , k}}{\partial t} ( t ) = - \{ \begin{matrix}{Φ}_{i + \frac{1}{2} , j , k} {α}_{i + 1 , j , k} {c}_{i + 1 , j , k} ( t ) - {Φ}_{i - \frac{1}{2} , j , k} {α}_{i - 1 , j , k} {c}_{i - 1 , j , k} ( t ) + \\ {Φ}_{i , j + \frac{1}{2} , k} {α}_{i , j + 1 , k} {c}_{i , j + 1 , k} ( t ) - {Φ}_{i , j - \frac{1}{2} , k} {α}_{i , j - 1 , k} {c}_{i , j - 1 , k} ( t ) + \\ {Φ}_{i , j , k + \frac{1}{2}} {α}_{i , j , k + 1} {c}_{i , j , k + 1} ( t ) - {Φ}_{i , j , k - \frac{1}{2}} {α}_{i , j , k - 1} {c}_{i , j , k - 1} ( t )\end{matrix} \}$$

Similarly, if all of the flows are outgoing, we have the local submodel

$$\frac{\partial {c}_{i , j , k}}{\partial t} ( t ) = - {α}_{i , j , k} {c}_{i , j , k} ( t ) ( {Φ}_{i + \frac{1}{2} , j , k} - {Φ}_{i - \frac{1}{2} , j , k} + {Φ}_{i , j + \frac{1}{2} , k} - {Φ}_{i , j - \frac{1}{2} , k} + {Φ}_{i , j , k + \frac{1}{2}} - {Φ}_{i , j , k - \frac{1}{2}} )$$

We can therefore locally estimate beforehand the identifiable parameter of these 64 (at most) submodels for all of the interior and border voxels (for example the terms

$${Φ}_{i + \frac{1}{2} , j , k} {α}_{i + 1 , j , k} , {Φ}_{i - \frac{1}{2} , j , k} {α}_{i - 1 , j , k} …$$

for the incoming flow submodel, the term

$${α}_{i , j , k} ( {Φ}_{i + \frac{1}{2} , j , k} - {Φ}_{i - \frac{1}{2} , j , k} + {Φ}_{i , j + \frac{1}{2} , k} - {Φ}_{i , j - \frac{1}{2} , k} + {Φ}_{i , j , k + \frac{1}{2}} - {Φ}_{i , j , k - \frac{1}{2}} )$$

for the outgoing flow submodel) by adjusting for example the corresponding bilinear submodels on the basis of linear least squares that may be constrained on [symbol] or [symbol] if the sign of the identifiable parameter is known a priori (e.g.

$${Φ}_{i + \frac{1}{2} , j , k} {α}_{i + 1 , j , k} < 0 , {Φ}_{i - \frac{1}{2} , j , k} {α}_{i - 1 , j , k} > 0 …$$

for the submodel with incoming flows). Once each model is thus adjusted, we can calculate a quantity such as the probability of the data by knowing the submodel, the AIC (Akaike Information Criterion) or the BIC (Bayesian Information Criterion) for each submodel so as to determine the best adjustment submodel and consequently the sign of the six volumetric flows in each interior or border voxel.

Two estimations of the sign of a volumetric flow across a face are thus obtained when said face is shared by two interior or border voxels. If these two estimations of the volumetric flow sign match, then the two corresponding local submodels are chosen in order to obtain the global kinetic model to be adjusted at a later stage. If these two estimations do not match, then we can advantageously adjust the local kinetic model for the pair of interior or border voxels sharing the face across which the volumetric flow is taken. We then have for example 2¹²⁻¹=2048 submodels in accordance with the signs of the eleven volumetric flows across the eleven faces of this pair of voxels. The adjustment of this local kinetic model is achieved as previously described, by adjusting for example the corresponding bilinear submodels by linear least squares that may be constrained. The sign of these eleven volumetric flows is thus determined, in particular the one whose sign did not match on completing the first estimation step.

Clearly, despite this second local estimation step of the volumetric flow signs, some mismatches might exist and, consequently, the resulting global kinetic model might not be perfectly specified locally. However, these inevitable local specification errors have only a local and moderate effect since, by definition, they appear for small volumetric flows in terms of absolute value so that the incorrect local terms in the global kinetic model are themselves small in terms of absolute value.

Apart from its simplicity, the advantage of this embodiment compared to the adjustment of a global analytical kinetic model lies mainly in the fact that in practice it allows a number of arbitrarily large parameters to be estimated with conventional calculation means. Furthermore, this embodiment can advantageously be used to initiate an estimation method of a quantity of interest from an analytical global kinetic model such as the one previously described. We can also advantageously constrain the α values to be greater than

$${α}_{min} = \frac{1}{V \cdot ( 1 - {Ht}^{′} )}$$

by setting α′=α−αₘᵢₙ and by estimating the α′ values at each α(tₗ)←α^{LS}[Φ(tₗ)] step of a previously described alternating linear least squares method by adopting a constrained non-negative linear least squares method. Similarly, we can constrain the volumetric flows to have their signs the same as those previously estimated locally by again using a constrained linear least squares method.

If the measurement noise is additive, white, stationary, uncorrelated, Gaussian and heteroscedastic, according to a third embodiment of the invention, the least squares previously described can be replaced by weighted least squares

$${χ}^{2} ( Φ , α , {t}_{0} ) = {\sum }_{( i , j , k )} {\sum }_{l = 1}^{N} {[ {c}_{i , j , k}^{exp} ( {t}_{l} ) - {c}_{i , j , k} ( {t}_{l} ) ]}^{2} / {σ}_{i , j , k}^{2} .$$

The step for estimating the quantity of interest using a method according to the invention can then involve implementing a feasible weighted least squares method provided that the σ_{i,j,k} values can be estimated separately.

According to a second variation of this embodiment, an appropriate global kinetic model is again determined beforehand among the possible a priori 2^{N}^{_{Φ}} models by estimating the volumetric flow signs for all of the interior or border voxels by adjusting the invariant local kinetic models according to the direction of flow across the six faces of said voxels.

Such an invariant model is obtained as follows. The signed mass exiting across face Fᵢ during the time lapse [t,t+∂t] is written mᵢ(t)=Vᵢ(t)·cᵢ^{S}(t)=cᵢ^{S}(t)·Φᵢ^{P}(t)·∂t. As the flow Φᵢ^{P}(t) is by definition invariant, except for the sign, by reversing the direction of flow across face Fᵢ, the signed mass mᵢ(t) is itself invariant, except for the sign, by said reversal if and only if the mass concentration cᵢ^{S}(t) is itself invariant by this reversal, i.e. if it is a symmetrical function of the plasma concentrations c^{P}(t) and cᵢ^{P}(t) only. By the principle of continuity, we should then put

$${c}_{i}^{s} ( t ) = \frac{{c}_{i}^{P} ( t ) + {c}^{P} ( t )}{2} .$$

We thus obtain a first invariant local model according to the directions of flow:

$$\frac{\partial c}{\partial t} ( t ) = - \frac{1}{V} \cdot {\sum }_{i = 1}^{6} {Φ}_{i}^{P} ( t ) \cdot \frac{{c}_{i}^{P} ( t ) + {c}^{P} ( t )}{2} = - \frac{1}{2} \cdot {\sum }_{i = 1}^{6} {Φ}_{i}^{P} ( t ) \cdot [ \frac{{c}_{i} ( t )}{{V}_{i}^{P}} + \frac{c ( t )}{{V}^{P}} ] = - \frac{1}{2} \cdot {\sum }_{i = 1}^{6} \frac{{Φ}_{i}^{P} ( t )}{{V}_{i}^{P}} \cdot {c}_{i} ( t ) - \frac{c ( t )}{2 \cdot {V}^{P}} \cdot {\sum }_{i = 1}^{6} {Φ}_{i}^{P} ( t )$$

if we assume the flow to be permanent during the acquisition time and a second invariant local kinetic model of the type

$$\frac{\partial c}{\partial t} ( t ) = - \frac{1}{2} \cdot {\sum }_{i = 1}^{5} \frac{{Φ}_{i}^{P}}{{V}_{i}^{P}} \cdot {c}_{i} ( t ) + \frac{1}{2} \cdot \frac{{c}_{6} ( t )}{2 \cdot {V}_{6}^{P}} \cdot {\sum }_{i = 1}^{5} {Φ}_{i}^{P}$$

if we assume the flow to be always permanent.

These two models can be expressed, as described previously, in the form of models with are now bilinear, and not only piecewise bilinear, in their volumetric flows and subvolumes. We can therefore advantageously adjust them to the experimental data in all of the interior or border voxels by adopting an alternating linear least squares method as described previously. We thus obtain in particular an estimation of the sign of each flow to be estimated, thus enabling us to determine an appropriate non-invariant global kinetic model to be adjusted by a method such as those described previously.

All of the embodiments according to the invention are immediately applicable to the data of the perfusion or permeability imaging techniques currently available once they are volumetric. Specifically, there must be no inter-slice void, otherwise there would be no interior voxel. An estimation method according to the invention can advantageously include a prior time coregistration step of the signals for each tomographic slice of the volume imaged if their acquisitions are not simultaneous. If adjusting an analytical global model, this can be done by estimating the theoretical concentration curves for each slice on the same fine time grid. If adjusting a model, this can be done by pre-interpolating all of the signals on this same fine time grid. Furthermore, an estimation method according to the invention can advantageously include a step to pre-segment the volume of the organ of interest in order to determine the exterior and border voxels.

It should be pointed out that, unlike known state-of-the-art methods which at most enable relative values defined up to a multiplicative constant to be obtained (i.e. relative blood flow—rBF, relative blood volume—rBV), the estimations of volumetric flows and the subvolumes of the fluid transporting the contrast agent in a voxel according to the invention are almost absolute particularly when the voxel is located in an area of homogenous tissue, whatever the contrast agent tomographic technique used, particularly nuclear magnetic resonance imaging techniques. In fact, the method is not already subject to the problem of partial volumes because these are taken into account by construction. Moreover, in an area of homogenous tissue, it is reasonable to consider that the relationship between the signals obtained by the imaging techniques and the concentration curves (particularly the values of the k constants previously described) is almost the same for all of the voxels in this area. The estimation of the flows and volumes in a voxel depends basically on the concentrations in this voxel and on its six neighbours at most, if the concentrations are clearly determined up to said k constant for these seven voxels, they are indeed almost absolute.

In addition to the volumetric flows and the subvolumes estimated as previously described for each element of volume, the invention allows us to determine other quantities of interest. For the sake of brevity, we will consider the case where said elements of volume are parallelepiped voxels but the quantities of interest are generalised to any pavings of polyhedra.

As the faces of a voxel are flat surfaces, we have for example for face F oriented according to the vector \vec{x}

$$\begin{matrix}{Φ}_{i}^{v} = {\int \int }_{F} \vec{v} ( x , y , z ) \cdot \vec{d Σ} \\ = {\int \int }_{F} \vec{v} ( x , y , z ) \cdot \vec{x} d S \\ = {\int \int }_{F} {v}_{x} ( y , z ) d y d z \\ = {S}_{x} 〈 {v}_{x} 〉\end{matrix}$$

where

$${S}_{x} = {\int \int }_{F} d y d z$$

is the measurement of F and [symbol] vₓ [symbol] is the average component along the axis \vec{x} of the velocity of the fluid transporting the contrast agent passing across it.

Using the preceding orientation conventions and notations, the processing unit according to the invention can thus calculate a vectorial quantity of interest in the form of a canonical mean velocity vector field in the interior or border voxels by

$${\vec{v}}_{i , j , k} ≡ {( {v}_{x} , {v}_{y} , {v}_{z} )}_{i , j , k} ≡ ( \frac{{Φ}_{i - \frac{1}{2} , j , k} + {Φ}_{i + \frac{1}{2} , j , k}}{2 {S}_{x}} , \frac{{Φ}_{i , j - \frac{1}{2} , k} + {Φ}_{i , j + \frac{1}{2} , k}}{2 {S}_{y}} , \frac{{Φ}_{i , j , k - \frac{1}{2}} + {Φ}_{i , j , k + \frac{1}{2}}}{2 {S}_{z}} )$$

or in the form of a mean flow velocity taking a norm like the Euclidean norm [symbol] v_{i,j,k} [symbol] =\sqrt{vₓ²+v_{y}²+v_{z}²} of said velocity vector.

Let Sᵢ be the area of the face Fᵢ, i=1,6 of the voxel and Lᵢ the length of the voxel in the direction orthogonal to Fᵢ. The invention also envisages that the processing unit can calculate a quantity of interest in the form of a signed local Mean Transit Time (MTT) of the contrast agent from the centre of the current voxel to the centre of the neighbouring voxel across the face Fᵢ by

$${MTT}_{i} = \frac{{L}_{i}}{〈 {v}_{i} 〉} = \frac{{L}_{i} {S}_{i}}{{Φ}_{i}^{v}} = \frac{V}{{Φ}_{i}^{v}}$$

where V is the measurement of the voxel volume and Φᵢ^{v} is the volumetric flow exiting across previously estimated face Fᵢ.

Furthermore, according to the invention the processing unit can estimate quantities of interest in the form of vectors or vector fields such as particle acceleration (\vec{v}.\vec{∇})\vec{v} for a permanent flow, particle jerk or particle snap or scalar quantities such as a norm of said vectors.

Based on the vector field \vec{v}_{i,j,k} in all of the interior or border voxels, the invention also further envisages that the processing unit can estimate other quantities of interest in the form of current lines of the flow of fluid transporting the contrast agent, trajectories, emission lines from a given material point or even fluid lines.

In particular, the step of estimating the current lines can be implemented by determining the solutions of the differential equation

$$\frac{dx}{{v}_{x}} = \frac{dy}{{v}_{y}} = \frac{dz}{{v}_{z}}$$

as is customary practice in tractography, for example in the context of diffusion tensor imaging to display axons (fibre tracking). If the flow is permanent, the estimated current lines are confused with the trajectories of the fluid transporting the contrast agent and the emission lines.

In particular, the processing unit according to the invention can estimate a propagation time from a point upstream to a point downstream along a previously estimated trajectory.

Lastly, although the question “how is the tissue perfused?” is poorly worded because the open perfusion surface is not defined, nevertheless we can try to meet the need for a single perfusion measurement per voxel by introducing the total absolute flow

$${\sum }_{i = 1}^{6} \vert {Φ}_{i} \vert ,$$

the maximum absolute flow

$${max}_{i = 1 , 6} \vert {Φ}_{i} \vert ,$$

the total quadratic flow

$${\sum }_{i = 1}^{6} {Φ}_{i}^{2}$$

or the maximum quadratic flow

$${max}_{i = 1 , 6} {Φ}_{i}^{2} .$$

We need only bear in mind that these quantities are no longer physical parameters defined in the context of Fluid Kinematics.

The invention also envisages that the processing unit can calculate additional quantities associated with the quantities of interest previously described such as a confidence interval for an estimation of a quantity of interest, an odds bet for said confidence interval, a joint or marginal posterior probability distribution, an estimation of the probability of a kinetic model knowing the data, an estimation of a theoretical concentration curve, residues between an estimated theoretical concentration curve and an experimental concentration curve and their quadratic sum, an estimation of a theoretical signal, residues between an estimated theoretical signal and an experimental signal and their quadratic sum.

The invention advantageously envisages that the processing unit can format and even encode an estimated quantity of interest 14 in the form of a content 14′ that can be used by a possibly remote output device. The production of such content may depend on the man/machine interface provided to output the quantity or on the manner in which the user wishes to make use of it.

According to a second object, the invention concerns, like the prior art, a tomographic imaging analysis system as described in connection with FIGS. 1 and 2. It comprises a processing unit 4 as previously described cooperating with an output device 5 comprising a man/machine interface. Said system is capable of outputting images for a user 6 of an estimated quantity 14 using a method according to the invention implemented by said processing unit 4. This quantity may be translation into the form of a content 14′ processed by the processing unit 4 in a format appropriate for the man/machine interface of said output device 5.

Although the quantities of interest estimated according to the invention are all novel, some of them can be outputted for the user 6 in a form similar to that of certain quantities estimated according to the prior art. Thus, the output device 5 implements a method for outputting a quantity of interest relating to a flow of body fluid in an organ on the basis of experimental signals 15 delivered by a tomographic measurement system and relating to the concentrations of a contrast agent within given polyhedral volumes. Said method comprises a step for reading a quantity of interest 14 (or a content 14′ representing it) and outputting it via a suitable man/machine interface. The BF parameter map described in connection with FIG. 8 is a classic example of such an output.

Moreover, the invention enables estimation of quantities of interest that require output, also novel. In this case, the invention also concerns a novel output method.

FIGS. 9a, 9b, 10, 11 and 12 illustrate some examples of output of novel quantities of interest estimated according to the invention from the same patient case as that relating to FIG. 8. These outputs can currently be used by a practitioner via an output device comprising a suitable man/machine interface and by implementing an output method according to the invention.

Thus, the invention envisages an output device to display estimations of scalar parameters such as subvolumes, norms of velocity vectors or acceleration vectors, particle jerks or snaps, total absolute or quadratic flows, maximum absolute or quadratic flows in the form of choropleth tomographic “parameter maps” or three-dimensional images where the intensity or colour of each pixel or voxel depends on the estimated value in that pixel or voxel, for example in a linear manner. As an example FIG. 11 shows an estimation map of the Euclidean norms of the plasma velocity vectors according to the invention. A clear collapse of said plasma velocities can be seen in the same hypoperfused area 80 which is more clearly delimited than in FIG. 8 according to the prior art. Similarly, FIG. 10 shows an estimation map of plasma subvolumes processed by an output device according to the invention. Each pixel is coloured by a colour depending on the estimated value of the subvolume. Here too note the collapse of said subvolumes in the hypoperfused area 80 compared to the contralateral hemisphere.

For an associated quantity of interest according to the invention a polyhedral volume such as a volumetric flow, a mean velocity or a mean transit time across said face, the invention envisages the implementation by an output device 5 of an output method comprising a step for outputting a representation of said face depending on the value of the quantity of interest for said face. By way of example, FIG. 9a describes a representation in the form of a choropleth map

$${MF}_{i - \frac{1}{2} , j , k}$$

of the plasma volumetric flows across the respective faces i=½,j,k obtained by colouring each pixel of coordinates (i,j,k) of the map in a colour depending on the value of

$${Φ}_{i - \frac{1}{2} , j , k}$$

. Similarly, the quantity of interest can modulate the length, thickness, texture or more generally the geometry of the topology of the representation of said face.

The invention also envisages that the output method can consist in outputting a plurality of choropleth maps respectively associated with one of the faces of the polyhedral volumes. Thus, FIG. 9b shows a representation of the plasma volumetric flows across the six faces of parallelepiped volumes in the form of six choropleth maps.

$${MF}_{i + \frac{1}{2} , j , k} , {MF}_{i - \frac{1}{2} , j , k} , {MF}_{i , j + \frac{1}{2} , k} , {MF}_{i , j - \frac{1}{2} , k} , {MF}_{i , j , k + \frac{1}{2}} , {MF}_{i , j , k - \frac{1}{2}}$$

obtained in a manner similar to map

$${MF}_{i - \frac{1}{2} , j , k}$$

described in connection with FIG. 9a. Thus map

$${MF}_{i , j , k - \frac{1}{2}}$$

represents flows

$${Φ}_{i , j , k - \frac{1}{2}}$$

across the respective faces i,j,k−½. For each of the six maps, FIG. 8 shows a collapse of flows in absolute value in the same hypoperfused area 80, shown here in grey (not black as in FIG. 9) since the flows can now be positive or negative. We can see, thanks to a suitable interface, that the plasma volumetric flows estimated according to the invention allow hypoperfused areas to be identified. The same applies to the plasma flows shown in the map in FIG. 9a. The invention envisages that the user can choose the maps that he wishes to display by means of user commands.

Instead of outputting the quantities of interest for each face as described, for example, in FIG. 9b, an output method according to the invention envisages associating base colours to the faces of a polyhedral volume and colouring a representation of said volume in a synthesised colour by mixing said base colours, the respective intensities of said colours depending on the values of the quantity of interest estimated for each of said faces. For example, a representation of a parallelepiped volume (for example a voxel) can be coloured by hexachromy (advantageously by means of a CcMmYK colour model) with one base colour per face of said volume by mixing said colours according to the respective values of the six volumetric flows or six mean transit times or six velocities across each of the six faces of said parallelepiped volume. More generally, the invention envisages being able to output a representation of a polyhedral volume depending on the value of a quantity of interest associated with a face of said volume, for example by modulating the length, thickness, texture or more generally the geometry or topology of the representation of said volume instead and in place of the colour.

Some of the novel quantities of interest estimated according to the invention are vectorial, for example the velocity vectors, particle acceleration vectors, particle jerk vectors or particle snap vectors. A method of outputting said vectorial quantity of interest according to the invention may involve outputting by an appropriate man/machine interface (such as a screen, printer, etc.), for a given polyhedral volume, an arrow based on a representation of said volume whose length is proportional to a norm of the vectorial quantity associated with said volume and whose direction is that of said vectorial quantity (known as a quiver or velocity plot). FIG. 12 shows such a representation for the projections of plasma velocity vectors in the cut plane (x,y) in the form of a map. The hypoperfused area 80 is still clearly visible: we can in fact see that the velocities y are significantly lower than elsewhere, in line with what you would expect from a physiopathological point of view.

As a variation, a method of outputting said vectorial quantity of interest according to the invention may consist in respectively associating three primary colours such as red, green and blue with the three base vectors \vec{x}, \vec{y} and \vec{z} then colouring a representation of a polyhedral volume on the basis of said primary colours whose respective intensities depend on the components of said quantity.

Moreover, the invention allows estimation of trajectories, current lines, emission lines or even fluid lines. The invention therefore envisages a method of output consisting in outputting one of said estimations in the form of a representation of a three-dimensional parameterised arc in Euclidean space. In particular, the invention envisages that an output device can advantageously display on a screen at any moment a representation of the portion of said parameterised arc travelled up until that moment. This image or any other output can be made for example either in an animated manner or in a static manner by juxtaposing the representations of portions of said arc at different moments.

Furthermore, the invention envisages that a representation of a position in said parameterised arc at a given moment can depend on the estimated value of a quantity of interest according to the invention at said moment. For example, an output method implemented by a device according to the invention may consist in colouring said representation of a position with a colour depending on the estimated travel time required to reach this position from a given position of departure located upstream of said parameterised arc. Similarly, the length of a representation of a position in a parameterised arc at a given moment can depend on the estimated value of a quantity of interest at said moment such as the flow velocity or particle acceleration in that position in the case of a permanent flow.

More generally, the invention also envisages a method of output consisting in outputting via a suitable man/machine interface distance cartograms obtained by anamorphosis according to a quantity of interest of a graphic representation of interest. For example, such graphic representation can be a two- or three-dimensional output of the anatomy of an organ of interest displayed/printed on a screen or any other support deformed according to the travel time of the blood in the vascular system of this organ.

Furthermore, the invention may envisage outputting additional quantities, such as confidence intervals for these estimations, for example in the form of “maps or three-dimensional confidence outputs” as well as the odds bets for said intervals of confidence in the form of “maps or three-dimensional outputs of odds bets”. The invention also envisages by way of a preferred embodiment the output of distances between concentration curves of estimated and experimental theoretical signals such as the sum of squared errors (SSE) or the probability of the concentration curve or experimental signal knowing the model in the form of “three-dimensional error outputs or maps”. With respect to estimations of theoretical concentration curves, theoretical signals or even errors between concentration curves or theoretical and experimental signals, the invention envisages their display in the form of time series for each voxel where the user so requests.

Thanks to the above-described examples of output, the invention provides the user with a complete set of information that is particularly helpful for example for a practitioner when working out a diagnosis or making a decision about treatment, information which could not be available by using known state-of-the-art techniques. This has been made possible by adapting the processing unit 4 and the output device 5 cooperating with said unit in accordance with FIG. 1 or 2 respectively to estimate a quantity of interest 14 (or deliver a content 14′ representing said quantity) and to output the latter for the user 6 by means of a man/machine interface for example in the form of maps or three-dimensional outputs as illustrated in FIGS. 9a, 9b, 10, 11 and 12. This adaptation can be achieved once and for all by means of ad hoc dedicated computer programs whose instructions, which can be executed by processing means of the processing unit 4 and the output device 5, implement an estimation and/or output method according to the invention during their execution.

Thanks to the invention, the information delivered is thus more copious and more accurate. The information provided to the practitioner is thus of a sort to increase his confidence when making a diagnosis or deciding on treatment.

In order to improve the performance of the system according to the invention, the latter notably envisages that the processing unit can be equipped with dedicated material calculation means such as graphic microprocessors (known as Graphical Processing units—GPU),programmable logic circuits such as FPGA (Field—Programmable Gate Arrays) or calculation clusters. As a variation, the processing unit according to the invention may be supported by remote calculation means. The calculation time can thus be reduced considerably further, if necessary. The same applies to an output device envisaged by the invention. Furthermore, a processing unit and an output unit according to the invention may exist as a single entity.

As an example of application, we can list the main steps of implementation of the invention by means of a tomographic imaging analysis system, such as the one described in connection with FIG. 1 or 2:
opening a patient file or taking into account sequences of images by the processor (or pre-processor 7) unit 4 to select sequences of images of interest-in particular, selecting perfusion or permeability images I1 to In over time, on the basis of which the perfusion or permeability signals s(x,y,z,t) are obtained for each voxel, as shown in FIG. 5a;
pre-displaying, by means of a man-machine interface, images to enable a user 6 to identify slices or areas of interest;
configuring the processing unit 4 on the basis of a dedicated computer program and configuration parameters (input information to enable the estimation method according to the invention to be implemented;
choosing the quantity (or quantities) of interest to be estimated;
estimating by means of the processing unit 4 quantities of interest such as volumetric flows, subvolumes, mean transit times, absolute or quadratic total flows, absolute or quadratic maximum flows, velocities, accelerations, jerks, particle snaps or their Euclidean norm, trajectories, current lines, emission lines or fluid lines, etc.;
estimating additional quantities of interest such as confidence intervals for the estimations of said quantities of interest, odds bets for said intervals of confidence, joint or marginal posterior probability distributions, the probability of the model knowing the data, estimated theoretical concentration curves, residues between estimated theoretical curves and experimental curves and their quadratic sums, estimated theoretical intensity signals, residues between estimated theoretical signals and experimental signals and their quadratic sums, etc.;
delivering said estimated quantities of interest 14 to an output device 5 (if necessary, previously adapted by means of a dedicated computer program according to the invention) so that the latter ultimately outputs them via a suitable man/machine interface for example in the form of maps or three-dimensional images;
optionally displaying maps or three-dimensional confidence outputs or odds bets for these confidence intervals, quadratic error maps, estimated theoretical signals or concentration curves (etc.) for certain voxels chosen by the user (commands 16) via an interface of the device 5;
assisted selecting by the practitioner of said pathological area of interest, characterised by an anomaly in the distribution of one or more quantities of interest;
identifying an area of abnormally perfused tissues that may be connected to an injured area and for which the practitioner will be able to refine his diagnosis and be efficiently assisted when making his decision on treatment (e.g. intravenous thrombolysis in order to reabsorb the blood clot for example in the treatment of certain cerebral vascular accidents);
producing, by the processing unit 4 or by the output unit 5, certain additional quantities, such as a ratio of the volumes of injured and abnormally perfused areas.

The invention has been described preferably through an application relating to medical imaging (perfusion or permeability imaging in particular). However, the invention is not limited to this preferred example of application. Thus, the invention concerns any method or system for estimating a quantity of interest relating to a flow within a kinematic system. The invention could be used to estimate and deliver an image concerning the flow of a fluid within, for example, an underground system or within any other body across which a fluid passes and for which characterisation is required.

1. A method for producing an estimation of a quantity of interest relating to a flow of fluid in a kinematic system based on experimental signals delivered by a tomographic measurement system and relating to concentrations of a contrast agent within given polyhedral volumes, comprising, in a processing unit, estimating said quantity of interest on the basis of a kinematic and parametric model comprising a plurality of parameters including a flow across a face of one of said given polyhedral volumes.

2. The method according to claim 1, wherein said kinematic and parametric model comprises a plurality of parameters including a flow across each face of one of said given polyhedral volumes.

3. The method according to claim 1, wherein the kinematic and parametric model is expressed in the form of a piecewise bilinear model in the volumetric flows across the faces of one of said given polyhedral volumes and subvolumes.

4. The method according to claim 3, wherein the step for estimating said quantity of interest comprises a step for estimating the parameters of the model on the basis of an alternating linear least squares method.

5. The method according to claim 1, further comprising a step for producing an additional quantity associated with the estimated quantity of interest or associated with said kinematic and parametric model.

6. The method according to claim 1, the flow being that of a body fluid in an organ of interest.

7. The method according to claim 1, wherein the estimated quantity of interest is a flow across a face of a given polyhedral volume, a flow per unit of surface, a subvolume of said given polyhedral volume, a flow velocity vector, a flow velocity, a local mean transit time from a given polyhedral volume to a neighbor of said given polyhedral volume, a particle acceleration vector, a particle acceleration, a particle jerk vector, a particle jerk, a particle snap vector, a particle snap, a total quadratic or absolute flow or a maximum quadratic or absolute flow.

8. The method according to claim 1 wherein the estimated quantity of interest is a field of flows across respective faces of given polyhedral volumes, a field of subvolumes of said given polyhedral volumes, a field of flow velocity vectors, a field of flow velocities, a position of a material point of the fluid, a range of local mean transit times from a polyhedral volume to a neighbor of said given polyhedral volume, a field of particle acceleration vectors, a field of particle accelerations, a field of particle jerk vectors, a field of particle jerks, a field of particle snap vectors, a field of particle snaps, a field of total absolute or quadratic flows, a field of maximum absolute or quadratic flows or a propagation time along a trajectory of the flow.

9. The method according to claim 8, further comprising, when the estimated quantity of interest is a field of flow velocity vectors, a step for estimating a trajectory, a current line, an emission line or a fluid line based on said estimated field of velocity vectors.

10. The method according to claim 1, said method including a step for producing a content representing said quantity of interest.

11. The method according to claim 10, further comprising delivering the content to an output device.

12. A method for outputting a quantity of interest estimated in accordance with the method according to claim 1, said quantity of interest relating to a flow of body fluid in an organ on the basis of experimental signals delivered by a tomographic measurement system and relating to the concentrations of a contrast agent within given polyhedral volumes, said output method being implemented by an output device comprising a man/machine interface, and comprising a step for outputting by said man/machine interface a representation of a face of a polyhedral volume depending on the value of the quantity of interest for said face.

13. The method for outputting a quantity of interest estimated in accordance with the method according to claim 1, said quantity of interest relating to a flow of body fluid in an organ on the basis of experimental signals delivered by a tomographic measurement system and relating to the concentrations of a contrast agent within given polyhedral volumes, said output method being implemented by an output device comprising a man/machine interface and comprising a step for outputting by said man/machine interface a representation of a plurality of faces of a polyhedral volume depending on the values of the quantity of interest for said faces.

14. A method for outputting a quantity of interest estimated in accordance with the method according to claim 1, said quantity of interest relating to a flow of body fluid in an organ on the basis of experimental signals delivered by a tomographic measurement system and relating to the concentrations of a contrast agent within given polyhedral volumes, said output method being implemented by an output device comprising a man/machine interface and comprising a step for outputting by said man/machine interface a representation of a polyhedral volume depending on the value of said quantity of interest associated with a face of said polyhedral volume.

15. The method according to claim 14, wherein the quantity of interest is vectorial and the step of output by the man/machine interface comprises outputting an arrow whose length is proportional to a norm of the vectorial quantity associated with said volume and whose direction is that of said quantity.

16. The method according to claim 14, wherein the quantity of interest is vectorial and the step of output by the man/machine interface comprises outputting a representation of a polyhedral volume coloured on the basis of three primary colours whose respective intensities depend on the components of the vectorial quantity associated with said volume.

17. A method of outputting a trajectory, a current line, an emission line or a fluid line, respectively estimated in accordance with a method according to claim 9 and relating to a flow of body fluid in an organ based on experimental signals delivered by a tomographic measurement system and relating to concentrations of a contrast agent within given polyhedral volumes, said output method being implemented by an output device comprising a man/machine interface and comprising a step to output via said man/machine interface a representation of a parameterised arc corresponding to the trajectory or the current line or the emission line or the fluid line.

18. The method according to claim 17, wherein a representation of a position in a parameterised arc at each moment depends on the value of a quantity of interest at said moment.

19. The method according to claim 17 wherein at each moment, a representation of the portion of the parameterised arc travelled up until that moment is output.

20. A method of outputting a quantity of interest estimated in accordance with the method according to claim 1, said quantity of interest relating to a flow of body fluid in an organ based on experimental signals delivered by a tomographic measurement system and relating to concentrations of a contrast agent within given polyhedral volumes, said output method being implemented by an output device comprising a man/machine interface, and comprising a step for outputting, via said man/machine interface, a choropleth representation of a volume deformed by anamorphosis in accordance with said quantity of interest.

21. A processing unit comprising storage means and means to communicate with external devices cooperating with processing means, wherein:
the communication means are capable of receiving configured to receive from an external device experimental signals delivered by a tomographic measurement system, said signals relating to concentrations of a contrast agent within given polyhedral volumes of a kinematic system; and
the storage means comprise instructions that, when executed by processing means, cause the processing means to implement a method for estimating a quantity of interest according to claim 1.

22. The processing unit according to claim 21, wherein:
the communication means are also configured to deliver to an external device a content representing a quantity of interest; and
the storage means comprise instructions that, when executed by the processing means, cause the processing means to implement a method for estimating a quantity of interest according to claim 10.

23. An output device comprising storage means, a man/machine interface and means for communicating with external devices cooperating with the processing means, wherein:
the communication means are configured to receive from an external device a quantity of interest relating to a flow of body fluid in an organ based on experimental signals delivered by a tomographic measurement system and relating to concentrations of a contrast agent within given polyhedral volumes;
the man/machine interface is configured to output for a user a representation of the quantity of interest; and
the storage means comprise instructions that, when executed by processing means, cause the processing means to implement a method according to claim 12.

24. An output device comprising a man/machine interface and means for communicating with the outside world cooperating respectively with the processing means, characterised in that:
the communication means are configured to receive from an external device a content produced according to the method of claim 10 and representing a quantity of interest relating to a flow of body fluid in an organ based on experimental signals delivered by a tomographic measurement system and relating to concentrations of a contrast agent within given polyhedral volumes; and
the processing means are configured to read said content and output the representation of the quantity of interest.

25. A tomographic imaging analysis system comprising;
a processing unit having
means to communicate with external devices cooperating with processing means, configured to receive from an external device experimental signals delivered by a tomographic measurement system, said signals relating to concentrations of a contrast agent within given polyhedral volumes of a kinematic system; and
storage means comprising instructions that, when executed by processing means, cause the processing means to implement a method for estimating a quantity of interest according to claim 1: and
an output device cooperating with said processing unit and comprising a man/machine interface configured to output for a user a representation of the quantity of interest.

26. A tomographic imaging analysis method implemented by a system according to the preceding claim 25, comprising:
estimating a quantity of interest on the basis of a kinematic and parametric model comprising a plurality of parameters including a flow across a face of one of said given polyhedral volumes, said quantity of interest relating to a flow of body fluid in an organ on the basis of experimental signals delivered by a tomographic measurement system and relating to the concentrations of a contrast agent within given polyhedral volumes; and
outputting, via a man/machine interface, a representation of a face of a polyhedral volume depending on the value of said face said quantity of interest.

27. A non-transitory computer-readable storage means having stored thereon a computer program that, when executed by the processing means of a processing unit according to claim 21, causes said processing means to estimate of a quantity of interest relating to a flow of fluid in a kinematic system based on experimental signals delivered by a tomographic measurement system and relating to concentrations of a contrast agent within given polyhedral volumes, on the basis of a kinematic and parametric model comprising a plurality of parameters including a flow across a face of one of said given polyhedral volumes.

28. A non-transitory computer-readable storage means having stored thereon a computer program that, when executed by the processing means of a processing unit according to claim 22, causes said processing means to estimate of a quantity of interest relating to a flow of fluid in a kinematic system based on experimental signals delivered by a tomographic measurement system and relating to concentrations of a contrast agent within given polyhedral volumes, on the basis of a kinematic and parametric model comprising a plurality of parameters including a flow across a face of one of said given polyhedral volumes, and to produce content representing the quantity of interest.

29. A non-transitory computer-readable storage means having stored thereon a computer program that, when executed by the processing means of an output unit according to claim 23, causes said processing means to estimate of a quantity of interest relating to a flow of fluid in a kinematic system based on experimental signals delivered by a tomoqraphic measurement system and relating to concentrations of a contrast agent within given polyhedral volumes, on the basis of a kinematic and parametric model comprising a plurality of parameters including a flow across a face of one of said given polyhedral volumes, said quantity of interest relating to a flow of body fluid in an organ on the basis of experimental signals delivered by a tomoqraphic measurement system and relating to the concentrations of a contrast agent within given polyhedral volumes, by implementing an output method, comprising outputting, by a man/machine interface, a representation of a face of a polyhedral volume depending on the value of the quantity of interest for said face.
